(19) United States
(12) Patent Application Publication
(10) Pub. No.: US 2025/0227796 A1
(43) Pub. Date: Jul. 10, 2025

(54) METHOD AND APPARATUS FOR MEASUREMENT ON A CELL WITH SEMI PERSISTENT SYNCHRONIZATION SIGNAL IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/004,649

(22) Filed: Dec. 30, 2024

(30) Foreign Application Priority Data
Jan. 3, 2024 (KR) 1020240000844

(51) Int. Cl. H04W 76/20; H04W 24/10; H04W 56/00

(52) U.S. Cl. CPC H04W 76/20; H04W 24/10; H04W 56/0015

(57) ABSTRACT

A method and apparatus to support semi-persistent SSB transmission is provided. The method includes receiving an RRC message comprising a serving cell configuration IE for a first serving cell, performing measurement on synchronization signal of the first serving cell based on type of the first serving cell and a specific field in the serving cell configuration IE and performing measurement result report based on the measurement results on synchronization signal of the first serving cell. The specific field indicates a measurement object that is associated with the first serving cell. The physical broadcast channel (PBCH) is periodically transmitted in first type secondary cell and not transmitted in the second type secondary cell. UE determines that the first serving cell is the second type secondary cell if a field indicating no PBCH transmission is comprised in the serving cell configuration IE.

### CROSS-REFERENCE TO RELATED APPLICATION

This application claims priority to and the benefit of Korean Patent Application No. 10-2024-0000844, filed on Jan. 3, 2024, the disclosure of which is hereby incorporated herein by reference in its entirety.

### BACKGROUND

### Technical Field

The present disclosure relates to synchronization signal transmission for network energy efficiency in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

In the advancement of 5G networks, one significant focus is improving network energy efficiency. A key innovation in this area is Synchronization Signal Block (SSB) transmission. SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network.

Periodic transmission of SSBs degrades network energy efficiency especially in low load/traffic scenario.

### SUMMARY

Aspects of the present disclosure are to address the problems of periodic transmission of SSBs. The method includes receiving an RRC message comprising a serving cell configuration IE for a first serving cell, performing measurement on synchronization signal of the first serving cell based on type of the first serving cell and a specific field in the serving cell configuration IE and performing measurement result report based on the measurement results on synchronization signal of the first serving cell. The specific field indicates a measurement object that is associated with the first serving cell. The physical broadcast channel (PBCH) is periodically transmitted in first type secondary cell and not transmitted in the second type secondary cell. UE determines that the first serving cell is the second type secondary cell if a field indicating no PBCH transmission is comprised in the serving cell configuration IE.

### BRIEF DESCRIPTION OF THE DRAWINGS

FIG. 1A is a diagram illustrating the architecture of an 5G system and a NG-RAN.

FIG. 1B is a diagram illustrating a wireless protocol architecture in an 5G system.

FIG. 2A illustrates the overall operation of the UE and network.

FIG. 2B illustrates RRC connection establishment procedure.

FIG. 2C illustrates UE capability transfer procedure.

FIG. 2D illustrates RRC connection reconfiguration procedure.

FIG. 2E illustrates data transfer procedure in RRC_CONNECTED state.

FIG. 2F illustrates SS/PBCH block.

FIG. 3A illustrates the operation of the UE and network for SIB-less secondary cell.

FIG. 4A is a diagram illustrating measurement operations of the terminal.

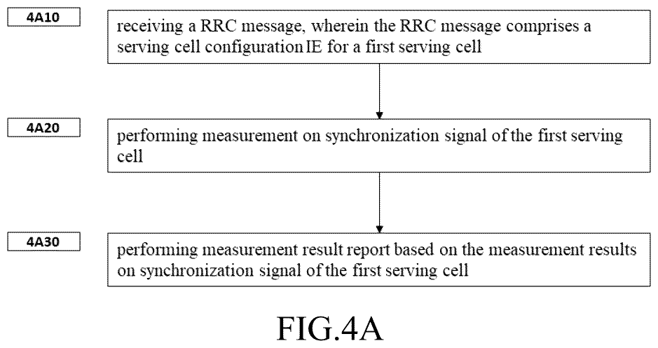

FIG. 4B is a diagram illustrating measurement reporting operations of the terminal.

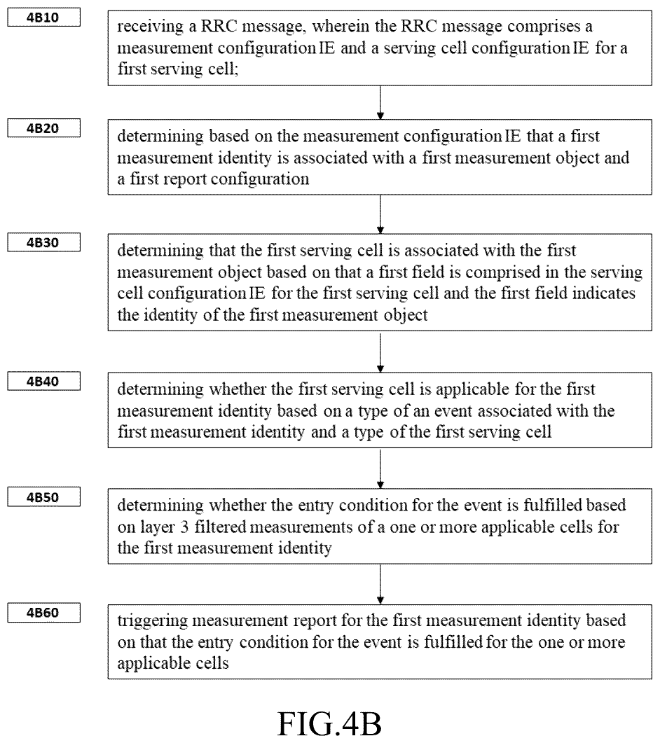

FIG. 4C is a diagram illustrating operations of the terminal for downlink control channel monitoring.

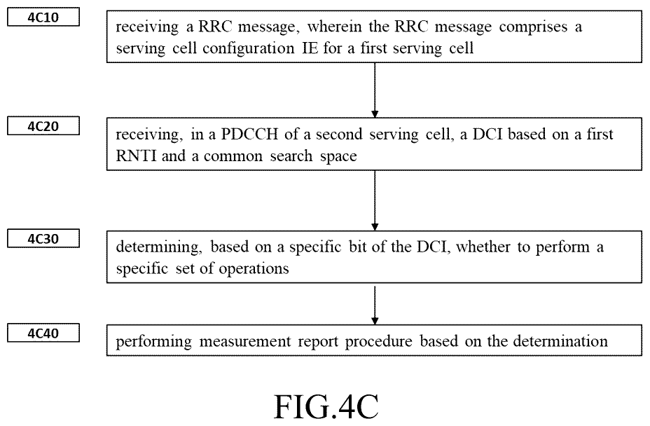

FIG. 5A is a block diagram illustrating the internal structure of a UE to which the disclosure is applied.

FIG. 5B is a block diagram illustrating the configuration of a base station according to the disclosure.

### DETAILED DESCRIPTION

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network, which results in unnecessary network energy consumption. One solution to remedy this problem is demand-driven SSB transmission.

On-demand SSB transmission represents a significant step towards sustainable and efficient 5G networks. By aligning signal transmissions with actual demand, networks can drastically reduce energy consumption without compromising connectivity. This approach not only benefits network operators through cost savings but also supports global efforts in reducing the carbon footprint of telecommunications infrastructure. To enable demand driven SSB transmission, new hardware, signaling and protocol are required.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

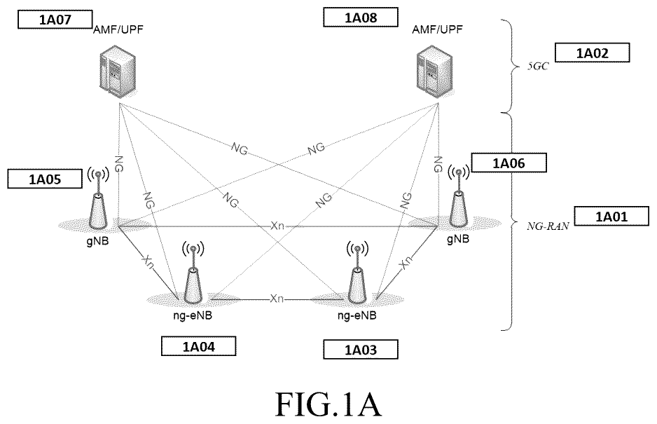

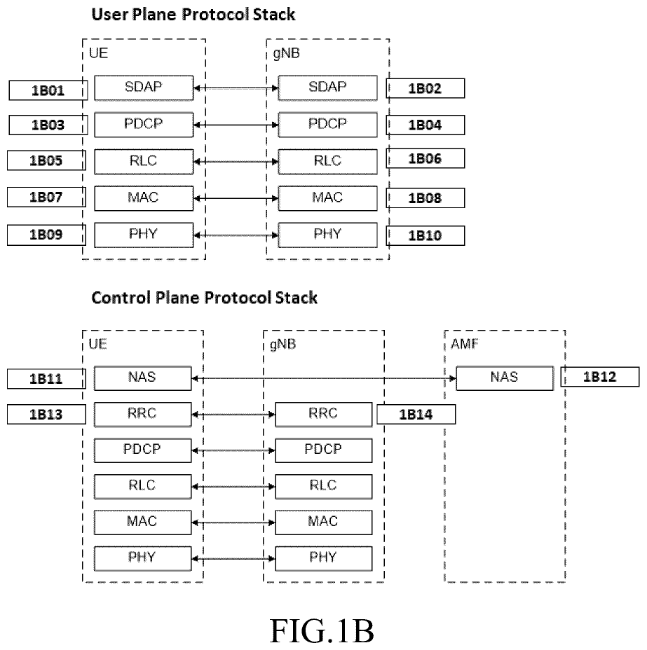

FIG. 1A is a diagram illustrating the architecture of an 5G system and a NG-RAN to which the disclosure may be applied.

5G system consists of NG-RAN 1A01 and 5GC 1A02. An NG-RAN node is either:
1: a gNB, providing NR user plane and control plane protocol terminations towards the UE; or
1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement reporting configuration for mobility and scheduling; and
1: Session Management; and
1: QOS Flow management and mapping to data radio bearers; and
1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

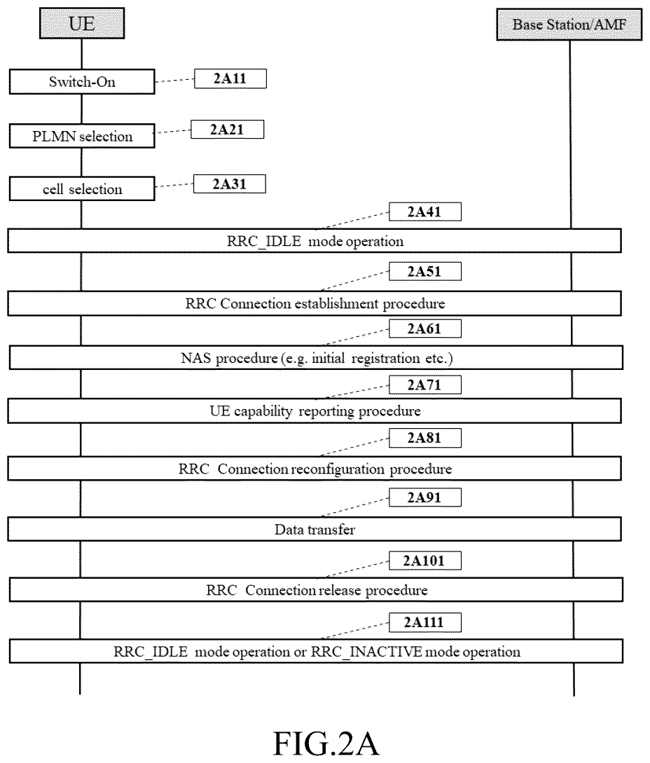

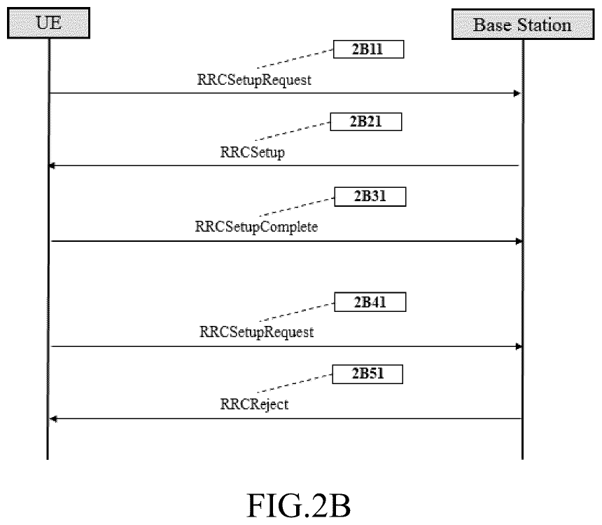

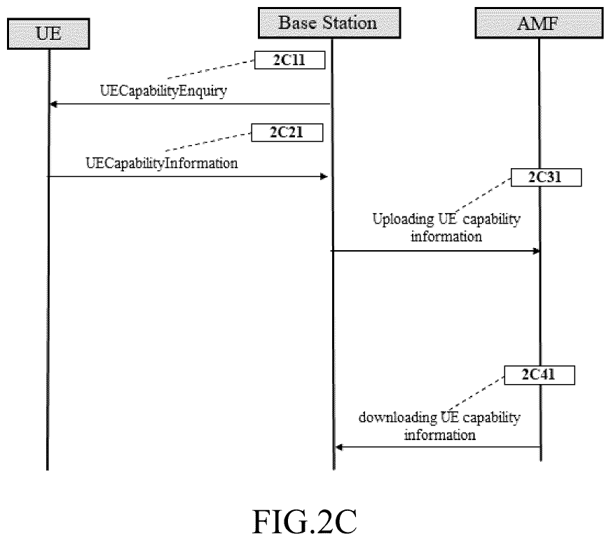

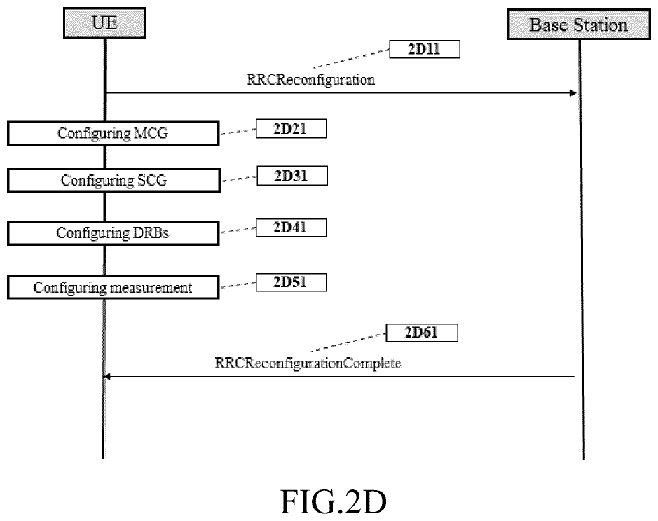

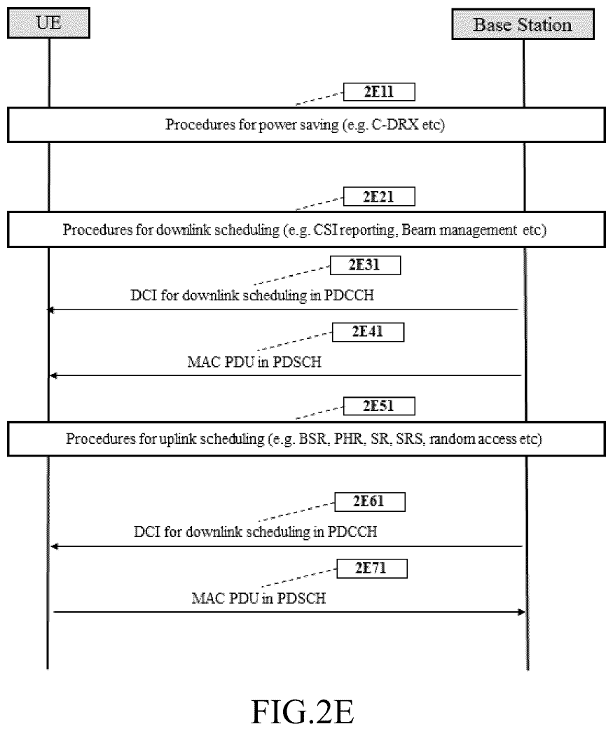

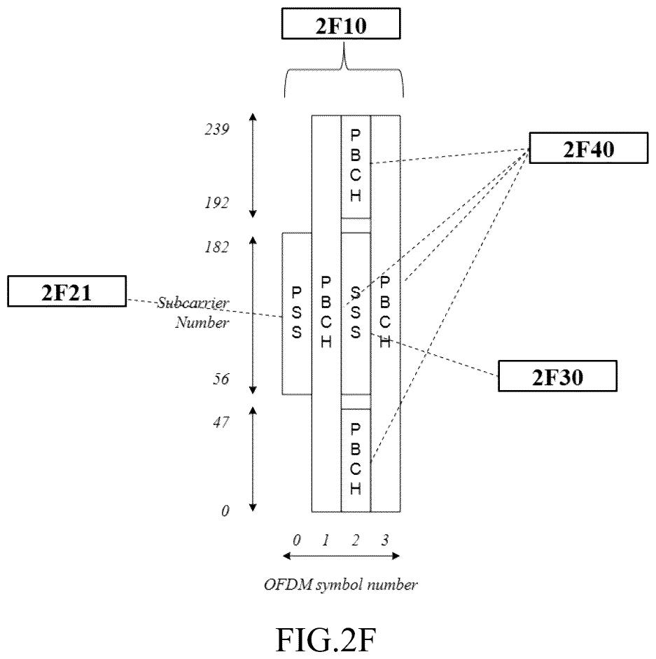

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high). The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
1: transmission of RRCSetupRequest by the UE 2B11;
1: reception of RRCSetup by the UE 2B21;
1: transmission of RRCSetupComplete by the UE 2B31.

Unsuccessful RRC connection establishment procedure comprises:
1: transmission of RRCSetupRequest by the UE 2B41;
1: reception of RRCReject by the UE 2B51;

RRCSetupRequest comprises following fields and IEs:
1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup comprises following fields and IEs:
1: radioBearerConfig field containing a RadioBearerConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCell Group;
1: perform the radio bearer configuration procedure in accordance with the received radioBearerConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-Identity InfoList;
1: include the s-NSSAI-List and set the content to the values provided by the upper layers;

FIG. 2C illustrates UE capability transfer procedure.

For network to configure the UE with appropriate configurations, the network needs to know the capability of the UE. For this end, the UE and the base station perform UE capability transfer procedure.

UE capability transfer procedure consists of exchanging UECapabilityEnquiry 2C11 and UECapability Information 2C21 between the UE and the base station.

In the UECapabiliityEnquiry, the base station indicates which RAT is subject to capability reporting. UE transmits the capability information for the requested RAT in the UECapability Information.

Once UECapabilityInformation is received, the capability information is uploaded to the AMF by the base station 2C31. When UE capability information is needed afterward, AMF provide it to the base station 2C41.

FIG. 2D illustrates RRC connection reconfiguration procedure.

Based on the reported capability and other factors such as required QoS and call admission control etc, the base station performs RRC reconfiguration procedure with the UE. RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2D11 and RRCReconfigurationComplete 2D61 between the base station and the UE.

RRCReconfiguration may comprises following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE;

Upon reception of RRCReconfiguration, UE processes the IEs in the order as below. UE may:
1: perform the cell group configuration for MCG based on the received masterCellGroup 2D21;
1: perform the cell group configuration for SCG based on the received secondary Cell Group 2D31;
1: perform the radio bearer configuration based on the received radioBearerConfig 2D41;
1: perform the measurement configuration based on the received measConfig 2D51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2E illustrates data transfer procedure in RRC_CONNECTED state.

The UE and the base station may perform procedures for power saving such as C-DRX 2E11. The configuration information for C-DRX is provided to the UE within cell group configuration in the RRCReconfiguration.

The UE and the base station may perform various procedures for downlink scheduling 2E21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2E31. The base station transmits to the UE PDSCH corresponding to the DCI and containing a MAC PDU 2E41.

The UE and the base station may perform various procedure for uplink scheduling 2E51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2E61. The base station transmits to the UE PDSCH corresponding to the DCI and containing a MAC PDU 2E71.

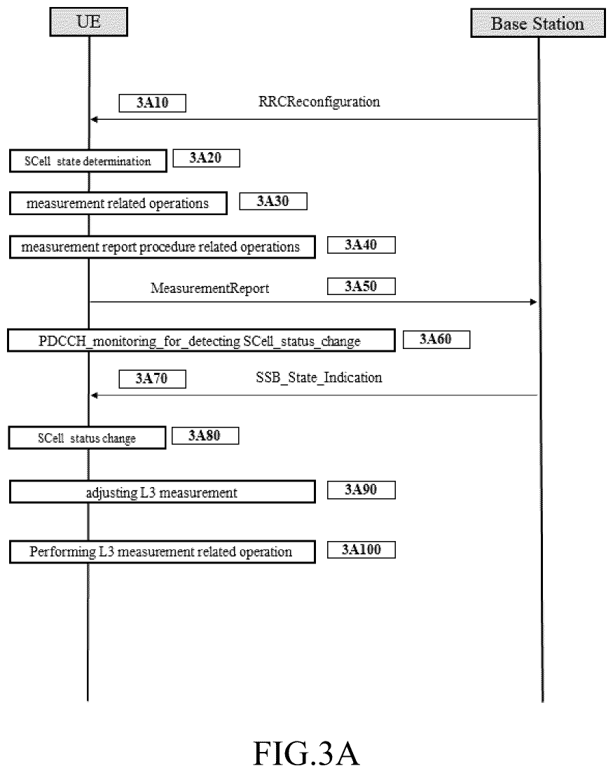

The Synchronization Signal and PBCH block (SSB) 2F10 consists of primary synchronization signals (PSS) 2F20 and secondary synchronization signals (SSS) 2F30. PSS and SSS occupies 1 symbol and 127 subcarriers. PBCH 2F40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell). FIG. 3A illustrates the operations for SSB-less SCell that operates demand-driven manner.

In Rel-18 NES, SSB-less SCell operation is limited to the scenario of inter-band CA for FR1 and co-located cells.

In the Rel-18 NES, for SSB-less SCell to work properly, at least one SCell having similar radio characteristics and similar geographical condition is required to transmit SSB continuously. Then UE performs the necessary operation for the SSB-less SCell such as time/frequency synchronization, L1/L3 measurements and SCell activation based on the associated SCell.

One scenario that Rel-18 SSB-less SCell does not cover is when only one FR2 SCell is configured to the UE. Then, since the FR2 SCell does not have associated SCell (having similar radio characteristics and similar geographical condition), FR2 SCell is forced to transmit SSB continuously.

To overcome such restriction, it is necessary to define a new set of operations between the UE and GNBs that enables dynamic turning on>off SSB transmissions.

In the new set of operations, GNB may switch the type/status/state of an SCell.

Table 1 below explains three states of the SCell.

TABLE 1

| | | Deactivated SCell with | Deactivated SCell without |
|---|---|---|---|
| | Active SCell (A-SCell) | SSB transmission (D1-SCell) | SSB transmission (D2-SCell) |
| Characteristics | most power consuming; | less power consuming than | least power consuming; and |
| | and shortest latency | A-SCell; and longer latency | longest latency for data |
| | for data transmission > | for data transmission > | transmission > reception |
| | reception. | reception (SCell activation | (SCell activation and SSB |
| | | is required before data | transmission activation |
| | | transmission > reception). | are required before data |
| | | | transmission > reception). |
| PDCCH | UE monitors PDCCH | UE does not monitor PDCCH | UE does not monitor PDCCH |
| PUSCH/PUCCH/SRS | UE transmit | UE does not transmit | UE does not transmit |
| | PUSCH/PUCCH/SRS | PUSCH/PUCCH/SRS | PUSCH/PUCCH/SRS |
| CSI reporting | UE report CSI | UE does not report CSI | UE does not report CSI |
| CSI measurement | UE measure CSI | UE does not measure CSI | UE does not measure CSI |
| SSB measurement | UE measure SSB with a | UE measures SSB with a | UE does not measure SSB |
| | periodicity determined | periodicity determined | |
| | based on DRX cycle | based on DRX cycle and | |
| | | measCycleSCell | |
| Beam Management | UE performs BM based | UE does not perform BM | UE does not perform BM |
| | on CSI | | |
| L3 RRM | Serving cell measurement | Serving cell measurement | No serving cell |
| measurement | for A1 and A2 | for A1 and A2 | measurement for A1 and A2 |
| | Applicable cell | Applicable cell | Not applicable |
| | for A3 and A5 | for A3 and A5 | cell for A3 and A5 |
| | Measurement results | Measurement results | Measurement results |
| | reported in | reported in | reported in |
| | MeasurementReport | MeasurementReport | MeasurementReport |

Based on traffic load and channel condition of a UE, GNB determines which state to be applied and performs necessary procedure for state transition. The transition is performed between the adjacent states/types (i.e. from A-SCell to D1-SCell or vice versa; from D1-SCell to D2-SCell or vice versa). Transition between A-SCell and D1-SCell is performed based on SCell Activation/Deactivation MAC CE. Transition between D1-SCell and D2-SCell is performed based on DCI 2_10. Transition from D2-SCell to A-SCell can be performed based on SCell Activation>Deactivation MAC CE (if a SCell is activated by the SCell Activation/Deactivation MAC CE and if the SCell is D2-SCell, transition from D2-SCell to A-SCell occurs; UE determines that SSB transmission of the serving cell will start at slot n+m3).

DCI 2_10 causes one or more UEs to change the status of a SCell. SCell A/D MAC CE causes a single UE to change the status of a SCell.

Table 2 summarizes state transitions.

TABLE 2

| State transition | | |
|---|---|---|
| direction | State transition caused by | State transition delay |
| A-SCell → D1-SCell | Reception of A/D MAC CE (the | When MAC CE is received in slot n, UE start |
| | corresponding Ci bit is set to 0 | operations related to D1-SCell at slot n + k. |
| | and the SCell was activated | # k = m + 3# x + 1. |
| | prior to receiving the A/D MAC | # slot n + m is a slot where HARQ-ACK for the |
| | CE); or | MAC CE is indicated. |
| | Expiry of sCellDeactivation | # x is number of slots per subframe for the SCS |
| | Timer associated with SCell | configuration of the PUCCH transmission. |
| D1-SCell → A-SCell | Reception of A/D MAC CE (the | When MAC CE is received in slot n, UE start |
| | corresponding Ci bit is set to 1 | operations related to A-SCell at slot n + k. |
| | and the SCell was deactivated | # k = m + 3# x + 1. |
| | prior to receiving the A/D MAC | # slot n + m is a slot where HARQ-ACK for the |
| | CE) | MAC CE is indicated. |
| | | # x is number of slots per subframe for the SCS |
| | | configuration of the PUCCH transmission. |
| D1-SCell → D2-SCell | Reception of DCI 2_10 (A | When DCI 2_10 is received in slot n of serving |
| | specific bit in block whose | cell a, UE starts operations related to D2-SCell |
| | block number corresponds to | at slot n + h of serving cell b. |
| | the SCell is set to 0 and the | # h = c + y; |
| | SCell was D1-SCell prior to | # c is a parameter having a different value |
| | receiving DCI 2_10) | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where DCI |
| | | 2_10 is received. |
| | | # Serving cell b is the serving cell of which |
| | | status changes based on the received DCI 2 10 |
| | | (e.g. the concerned SCell) is to occur. |
| | | # The specific DL BWP of the serving cell b is |
| | | the BWP indicated by |
| | | firstActiveDownlinkBWP-Id of the serving cell |
| | | b or is initialDownlinkBWP of the serving cell b. |
| | | # The specific DL BWP of the serving cell a is |
| | | the BWP where DCI 2_10 is received (or DCI |
| | | 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → D1-SCell | Reception of DCI 2_10 (A | When DCI 2_10 is received in slot n of serving |
| | specific bit in block whose | cell a, UE starts operations related to D1-SCell |
| | block number corresponds to | at slot n + h of serving cell b. |
| | | # h = c + y; |
| | | # c is a parameter having a different value |
| | | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | the SCell is set to 1 and the | ## Serving cell a is the serving cell where DCI |
| | SCell was D1-SCell prior to | 2_10 is received. |
| | receiving DCI 2_10) | # Serving cell b is the serving cell of which |
| | | status changes based on the received DCI 2_10 |
| | | (e.g. the concerned SCell) is to occur. |
| | | # The specific DL BWP of the serving cell b is |
| | | the BWP indicated by |
| | | firstActiveDownlinkBWP-Id of the serving cell |
| | | b or is initialDownlinkBWP of the serving cell |
| | | b. |
| | | # The specific DL BWP of the serving cell a is |
| | | the BWP where DCI 2_10 is received (or DCI |
| | | 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → A-SCell | Reception of A/D MAC CE (the | When MAC CE is received in slot n, UE start |
| | corresponding Ci bit is set to 1 | operations related to D1-SCell at slot n + k. |
| | and the SCell was D2-SCell | # k = m + q # x + 1 |
| | prior to receiving the A/D MAC | # slot n + m is a slot where HARQ-ACK for the |
| | CE) | MAC CE is indicated. |
| | | # x is number of slots per subframe for the SCS |
| | | configuration of the PUCCH transmission. |
| | | # q is an integer greater than 3. q is fixed in the |
| | | specification and stored in ROM of the UE. |
| A-SCell → D2-SCell | Reception of DCI 2_10 (A | When DCI 2_10 is received in slot n of serving |
| | specific bit in block whose | cell a, UE starts operations related to D2-SCell |
| | block number corresponds to | at slot n + h of serving cell b. |
| | the SCell is set to 0 and the | # h = c + y; |
| | SCell was A-SCell prior to | # c is a parameter having a different value |
| | receiving DCI 2_10) | depending on a specific SCS. If the specific |
| | | SCS is 15KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where DCI |
| | | 2 10 is received. |
| | | # Serving cell b is the serving cell of which |
| | | status changes based on the received DCI 2 10 |
| | | (e.g. the concerned SCell) is to occur. |
| | | # The specific DL BWP of the serving cell b is |
| | | the BWP indicated by |
| | | firstActiveDownlinkBWP-Id of the serving cell |
| | | b or is initialDownlinkBWP of the serving cell b. |
| | | # The specific DL BWP of the serving cell a is |
| | | the BWP where DCI 2_10 is received (or DCI |
| | | 2_10 is configured). |
| | | # y is: |
| | | ## 0 if SCS of the specific DL BWP of the |
| | | serving cell where DCI 2 10 is received and |
| | | SCS of the specific DL BWP of the SCell are |
| | | same; |
| | | ## otherwise, 1. |

At 3A10 UE receives from the GNB a RRCReconfiguration message. The RRCRecofniguration message comprises following fields/IEs.
measConfig field that comprises MeasConfig IE
spCellConfig field that comprises SpCellConfig IE
   newUE-Identity field that comprises RNTI-Value IE (for C-RNTI);
sCellToAddModList field that comprises one or more SCellConfig IEs; Each of SCellConfig may comprises:
   SSB_OFF_INDICATION field that indicates whether the SSB is transmitted in the corresponding SCell;
   positionInDCI_SSB_indication field that indicates the starting position of an information block of DCI format 2_10 (e.g., SSB_State_Indication) for this serving cell;
   valid measurement window field that indicates the time duration related to validity of the measurements taken for SCells that have been changed to D2-SCell recently.
SSB_State_Indication configuration IE;
   cell SSB_RNTI field that comprises RNTI for SSB_State_Indication;
   sizeDCI-2-10 field that indicates the size of SSB_State_Indication.

UE configures one or more SCells based on ServingCellConfigCommon IE and ServingCellConfig IE in SCellConifg. UE associates each SCell with a serving cell index. The serving cell index is derived from (or is equal to) SCellIndex IE. UE performs SCell state determination

At 3A20, UE performs SCell state determination.
For each SCell, UE determines state of each SCells:
   sCellState field is present in the SCellConfig IE, the corresponding SCell is in activated state (A-SCell);
   sCellState field is absent and SSB OFF_INDICATION field is absent, the corresponding SCell is deactivated state with SSB transmission (D1-SCell);
   sCellState field is absent and SSB_OFF_INDICATION field is present, the corresponding SCell is deactivated state without SSB transmission (D2-SCell).

UE associates each SCell with a MeasObject based on servingCellMO field in the corresponding ServingCellConfig IE. UE configures measurements based on MeasConfig IE.

After performing configurations based on the RRCReconfiguration, UE transmits to the GNB a RRCReconfigurationComplete.

At 3A30, UE performs measurement related operations. UE may perform serving_cell_measurement_operation for each serving cell. UE determines, through the operation, which to measure and which to not measure.

<serving_cell_measurement_operation>
for each serving cell for which servingCellMO is configured, UE performs followings:
   if the serving cell is PCell or A-SCell or D1-SCell;
      UE measure SS/PBCH blocks of the serving cell based on SSB-ToMeasure in the MeasObjectNR IE indicated by corresponding servingCellMO (or based on SSB-ToMeasure in the ServingCellConfigCommon); and
      UE derive layer 3 filtered RSRP and RSRQ per beam for the serving cell based on SS/PBCH block;
   if the serving cell is D2-SCell;
      UE does not measure SS/PBCH blocks of the serving cell;
      UE does not derive layer 3 filtered RSRP and RSRQ per beam for the serving cell.

UE performs evaluation on measurement report triggering. UE may perform, following in the order:
applicable_cell_determination to determine applicable cells and neighbouring cells;
determining_whether_to_perform_measurement_reporting_triggering_evaluation;
measurement_report_triggering_evaluation;
measurement_report_initiating_on_entering or measurement_report_initiating_on_leaving or both; and
cell TriggeredList_upadte.

UE performs following for applicable_cell_determination.
For first type event,
   For a measId that is configured with a first type event (alternatively, for each measId, for which the first type event is configured in the corresponding reportConfig):
      UE considers only the serving cell to be applicable for the first type event (alternatively, UE consider a specific SCell to be applicable for the event; the specific SCell is the SCell that is associated with a specific measObject; the specific measObject is associated with a specific reportConfig; the specific reportConfig configures the first type event).
For second type event,
   For a measId that is configured with a second type event (alternatively, for each measId, for which the second type event is configured in the corresponding reportConfig):
      if the concerned measObjectNR (the measObjectNR associated with the measId) is associated with a SCell; and
      if the SCell associated with the measObjectNR is A-SCell or D1-SCell;
         UE considers the SCell to be a neighbouring cell;
         if useAllowedCellList is set to true and if the SCell is included in the allowedCellsToAddModList,
         UE considers the SCell to be applicable.
         if useAllowedCellList is set to true and if the SCell is not included in the allowedCellsToAddModList,
         UE considers the SCell to be not applicable.
         if useAllowedCellList is set to false and if the SCell is not included in the excludedCellsToAddModList,
         UE considers the SCell to be applicable.
         if useAllowedCellList is set to false and if the SCell is included in the excludedCellsToAddModList,
         UE considers the SCell to be not applicable.
      if the SCell associated with the measObjectNR is D2-SCell,
      UE considers the SCell neither neighbouring cell nor to be applicable.
For third type event,
   For a measId that is configured with a third type event (alternatively, for each measId, for which the third type event is configured in the corresponding reportConfig):
      if the concerned measObjectNR (the measObjectNR associated with the measId) is associated with a SCell,
         UE considers the SCell neither neighbouring cell nor to be applicable.

UE performs followings for determining_measurement_report_triggering_evaluation.

<determining_whether_to_perform_measurement_report_triggering_evaluation>
For first type event,
   For a measId that is configured with a first type event (alternatively, for each measId, for which the first type event is configured in the corresponding reportConfig):
      if the applicable cell for the first type event is A-SCell or D1-SCell,
         UE determines to perform measurement_reporting_triggering_evaluation for the measId;
      if the applicable cell for the first type event is D2-SCell,
         UE determines to not perform measurement_report_triggering_evaluation for the measId (and determines to perform neither measurement_report_initiating_on_entering nor measurement_report_initiating_on_leaving);
         UE determines to perform measurement_report_triggering_evaluation for the measId when a specific DCI 2_10 is received.
For second type event and third type event,
   For a measId that is configured with a second type event or a third type event:
      UE determines to perform measurement_report_triggering_evaluation for the measId.

UE determines types of events as follows.
First type event is an event that is related only to a specific serving cell.
   The specific serving cell is PCell or SCell that is associated with the corresponding ReportConfig (i.e. ARFCN of the serving cell is same as ARFCN of MeasObjectNR associated with the ReportConfiig #MeasId).
   Only the specific serving cell is applicable.
   Event A1 and Event A2 are first type event.
Second type event is an event that is related to a specific serving cell and one or more neighbouring cells.
   The specific serving cell is PCell.
   The one or more neighbouring cells comprises:
      neighbouring cells detected based on parameters in the associated measObjectNR; and
      SCell associated with the corresponding ReportConfig (i.e. ARFCN of the serving cell is same as ARFCN of MeasObjectNR associated with the ReportConfiig #MeasId).
   Some of the one or more neighbouring cells are applicable.
   Event A3 and Event A5 are second type event
Third type event is an event that is related to only neighbouring cells.
   The one or more neighbouring cells are neighbouring cells detected based on parameters in the associated measObjectNR.
   Some of the one or more neighbouring cells are applicable.
   Event A4 is third type event

UE performs followings for measurement_report_triggering_evaluation.

<measurement_report_triggering_evaluation>
For measurement_report_triggering_evaluation for an event (or for a measId associated with the event);
   UE determines to trigger measurement_report_initiating_on_entering if the following conditions are fulfilled.
      the entry condition applicable for this event is fulfilled for one or more applicable cells for all measurements after layer 3 filtering taken during timeToTrigger defined for this event; and
      at least one of the one or more applicable cells is not included in the cellsTriggeredList.
   UE determines to trigger measurement_report_initiating_on_leaving if the following conditions are fulfilled.
      the leaving condition applicable for this event is fulfilled for one or more applicable cells for all measurements after layer 3 filtering taken during timeToTrigger defined for this event; and
      at least one of the one or more applicable cells is included in the cellsTriggeredList.
         <measurement_report_initiating_on_entering>

For measurement_report_initiating_on_entering for a measId, UE may:
include the measurement reporting entry within the VarMeasReportList for this measId, if not included yet;
include the concerned cell(s) in the cellsTriggeredList defined within the VarMeasReportList for this measId (the concerned cell is the cell that triggered the measurement_report_initiating_on_entering);
if use T312 is set to true in reportConfig for this event:
   if T310 for the corresponding SpCell is running; and
   if T312 is not running for corresponding SpCell:
      start timer T312 for the corresponding SpCell with the value of T312 configured in the corresponding measObjectNR;
initiate the measurement reporting procedure.
   <measurement_report_initiating_on_leaving>

For measurement_report_initiating_on_leaving for a measId, UE may:
remove the concerned cell(s) in the cellsTriggeredList defined within the VarMeasReportList for this measId (the concerned cell is the cell that triggered the measurement_report_initiating_on_leaving);
if reportOnLeave is set to true for the corresponding reporting configuration
   initiate the measurement reporting procedure, as specified in 5.5.5;
if the cellsTriggeredList defined within the VarMeasReportList for this measId is empty:
   remove the measurement reporting entry within the VarMeasReportList for this measId;

UE performs followings for cellsTriggeredList_update.

For cellsTriggeredList_update for a measId, UE may:
if the entry condition applicable for the event associated with the measId is fulfilled for one or more cells for all measurements after layer3 filtering taken during timeToTriggered; and
if the one or more cells are not included in cellTriggeredList:
   include the one or more cells in the cellsTriggeredList for the MeasId; and
   initiate the measurement reporting procedure;
if the leaving condition applicable for the event associated with the measId is fulfilled for one or more of the cells for all measurements after layer3 filtering taken during timeToTriggered; and
if the one or more cells are included in cellTriggeredList:
   remove the one or more cells in the cellsTriggeredList for the MeasId; and
   initiate the measurement reporting procedure.

UE may remove a specific cell from cellTriggeredList in case that the cell state changes from A-SCell or D1-SCell to D2-SCell (due to reception of SSB_State_Indication). In this case, UE does not initiate the measurement reporting procedure for the MeasId even when the associated ReportConfig is configured with reportOnLeave.

At 3A40, UE performs measurement report procedure related operations as follows. UE triggers measurement report procedure based on the measurement related operations (e.g. based on determination whether to trigger measurement reporting procedure). Based on the determination, UE performs measurement reporting procedure. For measurement reporting procedure, UE may perform measurement result inclusion.

UE performs followings for measurement_result_inclusion through which UE may determine which serving cell's measurement result shall be included in the measurement report message.

<measurement_result_inclusion>
for each serving cell configured with servingCellMO,
   if the serving cell is PCell or A-SCell or D1-SCell,
      include the MeasResultServMO IE of the serving cell in the MeasResultServMOList IE;
   if the serving cell is D2-SCell, and if L3 filtered measurement results for D2-SCell determined within the valid_measurement_window is available (i.e. D2-SCell was D1-SCell at least valid_measurement_window before),
      include the corresponding MeasResultServMO IE in the MeasResultServMOList IE,
   if the serving cell is D2-SCell, and if L3 filtered measurement results for D2-SCell determined within valid_measurement_window is not available;
      not include the corresponding MeasResultServMO IE in the MeasResultServMOList IE.

Alternatively,
for each serving cell configured with servingCellMO,
   if the serving cell is PCell or A-SCell or D1-SCell,
      include the type1_MeasResultServMO IE of the serving cell in the MeasResultServMOList IE;
   if the serving cell is D2-SCell, and if L3 filtered measurement results for D2-SCell determined within valid_measurement_window is available (i.e. D2-SCell was D1-SCell at least valid_measurement_window before),
      include the type1_MeasResultServMO IE in the MeasResultServMOList IE,
   if the serving cell is D2-SCell, and if L3 filtered measurement results for D2-SCell determined within valid_measurement_window is not available;
      include the type2_MeasResultServMO IE in the MeasResultServMOList IE.

type1_MeasResultServMO IE comprises followings:
servCellId field that comprises ServCellIndex;
measResultServingCell field that comprises:
   physCellId field that comprises PhysCellId of the serving cell;
   resultsSSB-Cell field or resultsCSI-RS-Cell field that comprises RSRP #RSRQ of the serving cell;
   rsIndexResults field that comprises beam level measurement results of the serving cell;
measResultBestNeighCell field that comprises:
   physCellId field that comprises PhysCellId of the best neighboring cell;
   resultsSSB-Cell field or resultsCSI-RS-Cell field that comprises RSRP #RSRQ of the best neighboring cell;
   rsIndexResults field that comprises beam level measurement results of the best neighboring cell.

type2_MeasResultServMO IE comprises followings:
servCellId field that comprises ServCellIndex;
   measResultServingCell field that comprises:
      physCellId field that comprises PhysCellId of the serving cell;
   measResultBestNeighCell field that comprises:
      physCellId field that comprises PhysCellId of the best neighboring cell;
      resultsSSB-Cell field or resultsCSI-RS-Cell field that comprises RSRP #RSRQ of the best neighboring cell;
      rsIndexResults field that comprises beam level measurement results of the best neighboring cell.

At 3A50, UE transmits to GNB a MeasurementReport. The MeasurementReport comprises a MeasResultServMOList. GNB may determine to change the states of one or more SCells based on the measurement report. GNB may transmit SSB_State_Indication to change the state of the one or more SCells.

UE performs PDCCH_monitoring_for_detecting SCell_status_change.

UE performs followings for PDCCH_monitoring_for_detecting SCell_status_change.

### <PDCCH_monitoring_for_detecting SCell_status_change>

For SSB_State_Indication reception, UE monitors SSB_State_Indication CSS in one or more specific serving cells based on SSB_State_Indication_RNTI;
   configuration parameters for SSB_State_Indication_CSS is comprised in the SpCellConfig IE;
   the one or more specific serving cells may be:
      a PCell; and
      one or more SCells that is activated and of which active BWP is configured with the SSB_State_Indication_CSS;
For SCell A/D MAC CE reception, UE monitors USS based on C-RNTI in all serving cells that is currently activated;
   configuration parameters for USS is comprised in the SCellConfig IE and in SpCellConfig IE.

At 3A70, UE receives from GNB SSB_State_Indication. The SSB_State_Indication is carried in DCI format 2_10 or in a MAC CE. SSB_State_Indication indicates, for each cell:
SSB transmission will stop in a specific time point;
SSB transmission will start in a specific time point;
SSB transmission will continue; or
No SSB transmission will continue.
   <DCI format 2_10>

DCI format 2_10 is used for activating or de-activating the SSB transmission of one or multiple SCells for one or more UEs.

The following information is transmitted by means of the DCI format 2_10 with CRC scrambled by cell_SSB_RNTI:
block number 1, block number 2, . . . , block number N
   the starting position of a block associated with a serving cell is determined by the parameter positionInDCI_SSB_indication provided by higher layers (in a RRCReconfiguration) for the UE.

If the UE is configured to monitor DCI 2_10 with CRC scrambled by cell_SSB_RNTI, one or more blocks are configured for the UE by higher layers (in a RRCReconfiguration), with the following fields defined for each block:
SSB indication—number of bits determined by the following:
   If higher layer parameter positionInDCI_SSB_indication is configured
      1 bit; 0 indicates that SSB transmission is deactivated (no SSB transmission in the corresponding cell); 1 indicates that SSB transmission is activated (SSB is transmitted in the corresponding cell)
      0 bit otherwise.
SSB time offset-number of bits determined by the following:
   If higher layer parameter time_offset_InDCI_SSB_indication is configured
      5 bit; 0 indicates that SSB transmission is activated or deactivated in a predefined time point; 1 indicates that SSB transmission is activated or deactivated in the first SSB transmission occasion after slot n (or symbol n); . . . ; 31 indicates that SSB transmission is activated or deactivated in the 31-th SSB transmission occasion after symbol n; slot n (or symbol n) is the slot (symbol) that the DCI 2_10 is received. The SSB transmission occasion is determined from SSB-ToMeasure in the ServingCellConfigCommon of the SCell.
      0 bit otherwise.

The size of DCI format 2_10 is indicated by the higher layer parameter sizeDCI-2-10.

A block in DCI 2_10 is either a 6 bit or a single bit or a zero bit. Each block is associated with a SCell. The association between the block and the SCell (serving cell) is indicated by the parameter positionInDCI_SSB_indication field in the serving cell configuration information for the SCell. The highest possible value for positionInDCI_SSB_indication is first integer.

A Ci bit in SCell A/D MAC CE is a single bit. Each Ci bit is associated with a SCell. The association between the Ci and the SCell is derived from SCell index. The highest possible value for SCell index is second integer.

The first integer is greater than the second integer because the first integer is related with serving cells of plurality of terminals while the second integer is related with serving cells of a single terminal.

At 3A80, UE performs, based on DCI 2_10, SCell_status_change_determination. UE determines, for a SCell, whether the SSB transmission in the SCell is activated or deactivated based on received DCI 2_10.

### <SCell_status_change_determination>

A DCI 2_10 is received at slot n of a first cell (one of one or more specific serving cells) and the DCI 2_10 contains information related to a second cell:
if [SSB indication in a block number M that corresponds to the second sell is set to 0] and [the second cell is not activated when DCI 2_10 is received] and [the SSB has been transmitted in the second cell before the reception of DCI 2_10 (e.g. the second cell is D1-SCell)];
   UE determines that SSB transmission of the second cell will stop at specific time point of the second cell (or UE determines that SSB of the second cell will be unavailable after specific time point of the second cell);
   UE determines that SCell changes from D1-SCell to D2-SCell (e.g. state transition from D1-SCell to D2-SCell occurs).
if [a block number M that corresponds to the second cell is set to 1] and [the second cell is not activated when DCI 2_10 is received] and [the SSB was not transmitted in the second cell before the reception of DCI 2_10 (e.g. the SCell is D2-SCell)];
   UE determines that SSB transmission of the second cell will start at specific time point of the second cell (or UE determines that SSB of the second cell will be available after specific time point of the second cell);
   UE determines that the SCell changes from D2-SCell to D1-SCell (e.g. state transition from D2-SCell to D1-SCell occurs).
if [a block number M that corresponds to a second cell is set to 1] and [the second cell is not activated when DCI 2_10 is received] and [the SSB has been transmitted in the second cell before the reception of DCI 2_10 (e.g. the second cell is D1-SCell)];
   UE determines that SSB transmission of the second cell does not change (e.g. continue before and after reception of the DCI 2_10);
   UE determines that second cell stay as D1-SCell (e.g. state transition does not occur).
if [a block number M that corresponds to a second cell is set to 0] and [the second cell is not activated when DCI 2_10 is received] and [the SSB has been transmitted before the reception of DCI 2_10 (e.g. the second cell is D2-SCell)];
   UE determines that SSB transmission of the second cell does not change (e.g. no SSB transmission before and after reception of the DCI 2_10);
   UE determines that second cell stay as D2-SCell (e.g. state transition does not occur).

UE may ignore block number M if the corresponding second cell is A-SCell.

The specific time point is either slot n+h or determined from SSB time offset.

A SCell A/D MAC CE is received at slot n of a third cell (a serving cell among currently active serving cells) and the SCell A/D MAC CE contains information related to the second cell:
if [Ci bit that corresponds to the second cell is set to 1] and [the second cell is not activated when the SCell A/D MACE is received] and [the SSB has been transmitted before the reception of SCell A/D MAC CE (e.g. the second cell is D2-SCell)]
   UE determines that SSB transmission of the second cell will start at slot n+k #x+1 of the second cell (or UE determines that SSB of the second cell will be available after slot n+k #x+1 of the second cell);
   UE determines that the SCell changes from D2-SCell to A-SCell (e.g. state transition from D2-SCell to A-SCell occurs).

At 3A90, UE performs, considering the changed status, measurement related operations.
UE may perform serving_cell_measurement_operation_adjusted for each SCell.
UE performs evaluation on measurement report triggering.
   UE performs applicable_cell_determination_after_SCell_status_change to determine applicable cells and neighbouring cells.
   UE performs determining_whether_to_perform measurement_reporting_triggering_evaluation_after_SCell_status_change for measId configured with the first type event.
   UE performs measurement_report_triggering_evaluation.
   UE performs measurement_report_triggering_evaluation.
   UE may perform measurement_report_initiating_on_entering or measurement_report_initiating_on_leaving or both.
   UE may perform cellTriggeredList_upadte.

For serving_cell_measurement_operation_adjusted, UE performs as follows.

<serving_cell_measurement_operation_adjusted>
for each SCell for which servingCellMO is configured, UE performs followings:
   if the SCell was A-SCell or D1-SCell before reception of DCI 2-10; and
   if the SCell becomes D2-SCell due to reception of DCI 2-10 at slot n of a serving cell;
      UE performs followings at slot n+1 of the serving cell:
         stop measuring SS/PBCH blocks of the SCell;
         stop deriving layer 3 filtered RSRP and RSRQ per beam for the SCell (e.g. initialize Mn, Fn and Fn−1 to zero);
         remove the SCell in relevant cellsTriggeredList (to prevent D2-SCell fulfilling leaving condition and triggering measurement report procedure) where the SCell was included.
if the SCell was D2-SCell; and
   if the SCell becomes D1-SCell due to reception of DCI 2-10 at slot n of a serving cell;
      UE performs followings at slot n+c+y of the SCell:
         start measuring SS/PBCH block of the SCell based on SSB-ToMeasure in the ServingCellConfigCommon of the SCell;
         start deriving filtered RSRP and RSRQ per beam for the SCell (e.g. start updating Fn based on Mn and Fn−1)
   if the SCell becomes A-SCell due to reception of SCell A/D MAC CE at slot n of a serving cell;
      UE performs followings at slot n+m of a serving cell where HARQ ACK is transmitted;
         start measuring SS/PBCH block of the SCell based on SSB-ToMeasure in the ServingCellConfigCommon of the SCell;
         start deriving filtered RSRP and RSRQ per beam for the SCell (e.g. start updating Fn based on Mn and Fn−1)
            <applicable_cell_determination_after_SCell_status_change>
For first type event: (same as applicable_cell_determination),
   For a measId that is configured with a first type event (alternatively, for each measId, for which the first type event is configured in the corresponding reportConfig):
      UE considers only the serving cell to be applicable for the first event (alternatively, UE consider a specific SCell to be applicable for the event; the specific SCell is the SCell that is associated with a specific measObject; the specific measObject is associated with a specific reportConfig; the reportConfig configures the first type event).
For second type event,
   For a measId that is configured with a second type event (alternatively, for each measId, for which the second type event is configured in the corresponding reportConfig):
      if the concerned measObjectNR (the measObjectNR associated with the measId) is associated with a SCell,
         if the SCell associated with the measObjectNR was A-SCell or D1-SCell before reception of DCI 2_10 and becomes D2-SCell due to reception of DCI 2_10; or
         if the SCell associated with the measObjectNR was D2-SCell before reception of DCI 2_10 and continues to be D2-SCell due to reception of DCI 2_10,
         UE considers the SCell neither neighbouring cell nor to be applicable.
         if the SCell associated with the measObjectNR was D2-SCell before reception of DCI 2_10 and becomes D2-SCell due to reception of DCI 2_10; or
         if the SCell associated with the measObjectNR was A-SCell or D1-SCell before reception of DCI 2_10 and continues to be A-SCell or D1-SCell due to reception of DCI 2_10,
         UE considers the SCell to be a neighbouring cell as well;
         if useAllowedCellList is set to true and if the SCell is included in the allowedCellsToAddModList,
         UE considers the SCell to be applicable.
         if useAllowedCellList is set to true and if the SCell is not included in the allowedCellsToAddModList,
         UE considers the SCell to be not applicable.
         if useAllowedCellList is set to false and if the SCell is not included in the excludedCellsToAddModList,
         UE considers the SCell to be applicable.
         if useAllowedCellList is set to false and if the SCell is included in the excludedCellsToAddModList,
         UE considers the SCell to be not applicable.
         if the SCell associated with the measObjectNR is D2-SCell,
         UE considers the SCell neither neighbouring cell nor to be applicable.
For third type event (same as applicable_cell_determination),
   For a measId that is configured with a third type event (alternatively, for each measId, for which the third type event is configured in the corresponding reportConfig):
      if the concerned measObjectNR (the measObjectNR associated with the measId) is associated with a SCell,
         UE considers the SCell neither neighbouring cell nor to be applicable.
            <determining_whether_to_perform_measurement_report_triggering_evaluation_after_SCell_st atus_change>
For first type event:
   For a measId that is configured with a first type event (alternatively, for each measId, for which the first type event is configured in the corresponding reportConfig):
      if the applicable cell for the first type event becomes A-SCell or D1-SCell due to reception of DCI 2_10 or SCell A/D MAC CE; and
      if the applicable cell was D2-SCell before the reception of DCI2_10 or SCell A/D MAC CE;
         UE determines to start measurement_reporting_triggering_evaluation for the measId;
      if the applicable cell for the first type event becomes D2-SCell due to reception of DCI 2_10; and
      if the applicable cell was D1-SCell or A-SCell before the reception of DCI2_10;
         UE determines to stop measurement_reporting_triggering_evaluation for the measId;
            <cellsTriggeredList_update_after_SCell_status_chagne>

For cellsTriggeredList_update_after_SCell_status_change for a measId, UE may:
if a one or more cells included in the cellsTriggeredList becomes D2-SCell due to reception of DCI 2_10;
   remove the one or more cells in the cellsTriggeredList for the MeasId; and
   not initiate the measurement reporting procedure.
if the entry condition applicable for the event associated with the measId is fulfilled for one or more cells for all measurements after layer3 filtering taken during timeToTriggered; and
if the one or more cells are not included in cellTriggeredList:
   include the one or more cells in the cellsTriggeredList for the MeasId; and
   initiate the measurement reporting procedure;
if the leaving condition applicable for the event associated with the measId is fulfilled for one or more of the cells for all measurements after layer3 filtering taken during timeToTriggered; and
if the one or more cells are included in cellTriggeredList:
   remove the one or more cells in the cellsTriggeredList for the MeasId; and
   initiate the measurement reporting procedure.

At 3A100, UE performs measurement related operations based on the adjustment.

UE may perform followings for operations illustrated in FIG. 3A.

UE may determine to perform, for each measId, that is configured #associated with first type event (event related to serving cell only; event A1 and #or event A2), measurement_report_triggering_evaluation based on whether the applicable cell is D2-SCell or not.

UE may perform, for each measId that is configured #associated with second type event (event related to both serving cell and neighbouring cell; event A3 and #or A5), measurement_report_triggering_evaluation_type2.

<measurement_report_triggering_evaluation_type1>

For measId of which corresponding reportConfig is configured with first type event, UE determines whether to perform measurement_report_triggering_evaluation based on whether the applicable cell of the event is D2-SCell or not.

UE determines that applicable cell to the first type event is the SCell associated with the measObjectNR associated with the event.

UE determines to perform measurement_report_triggering_evaluation_type1 in case that the applicable cell is A-SCell or D1-SCell. UE determines to not perform measurement_report_triggering_evaluation_type1 in case that the applicable cell is D2-SCell.

For measId of which corresponding reportConfig is configured with eventA4, UE performs measurement_report_triggering_evaluation with applicable cells.

For each measId included in the measIdList within VarMeasConfig:
if event A1 or A2 is configured in the corresponding reportConfig:
   if the corresponding measObject is associated with A-SCell (e.g. 1: servingCellMO of the SCell indicates the measObjectId of the corresponding measObject and 2: the SCell is A-SCell) or if the corresponding measObject is associated with D1-SCell (e.g. 1: servingCellMO of the SCell indicates the measObjectId of the corresponding measObject and 2: the SCell is D1-SCell); and
   if the entry #leaving condition applicable for this event is fulfilled for the SCell for all measurements after layer 3 filtering taken during timeToTrigger defined for this event within the VarMeasConfig;
      UE performs measurement_reporting_operation for this measId:
   if the corresponding measObject is associated with D2-SCell (e.g. 1: servingCellMO of the SCell indicates the measObjectId of the corresponding measObject and 2: the SCell is D2-SCell);
      UE does not evaluate if the entry #leaving condition applicable for this event is fulfilled until a first point of time;
      UE start evaluating if the entry #leaving condition applicable for this event is fulfilled after the first point of time;
      UE does not perform measurement-reporting-operation for this measId until the first point of time; and
      UE performs measurement-reporting-operation for this measId after the first point of time.
      the first point of time is when D2-SCell change to D1-SCell (e.g. upon reception of SSB_ACTIVATION_COMMAND)

For each measId included in the measIdList within VarMeasConfig:
if event A1 or A2 is configured in the corresponding reportConfig;
   if the applicable cell is A-SCell or D-SCell 1:
      UE performs measurement-reporting-operation;
   if the applicable cell is D2-SCell:
      UE does not perform measurement-reporting-operation for this measId.
if the eventA3 or eventA5 is configured in the corresponding reportConfig:
   UE evaluates whether the entry #leaving condition applicable for this event is fulfilled for one or more applicable cells (among applicable cells of this event) for all measurements after layer 3 filtering taken during timeToTrigger defined for this event within the VarMeasConfig;
   UE performs measurement-reporting-operation for this measId if entry condition or leaving condition is fulfilled for at least one applicable cell.

UE determines the one or more applicable cells of this event as below.
if the corresponding measObject is associated with A-SCell (e.g. 1: servingCellMO of the SCell indicates the measObjectId of the corresponding measObject and 2: the SCell is A-SCell) or if the corresponding measObject is associated with D1-SCell (e.g. 1: servingCellMO of the SCell indicates the measObjectId of the corresponding measObject and 2: the SCell is D1-SCell);
   applicable cells comprise:
      SCell associated with the measObject that is linked with the measId; and
      any neighbouring cell detected based on parameters in the associated measObjectNR when the concerned cell is not included in the excludedCellsToAddModList defined within the VarMeasConfig for this measId;
if the corresponding measObject is associated with D2-SCell
   applicable cells comprise:
      any neighbouring cell detected based on parameters in the associated measObjectNR and not included in the excludedCellsToAddModList defined within the VarMeasConfig for this measId;
   applicable cells do not comprise:
      SCell associated with the measObject that is linked with the measId; and
      any neighbouring cell included in the excludedCellsToAddModList defined within the VarMeasConfig for this measId.

For measurement-reporting-operation, UE includes a measurement reporting entry within the VarMeasReportList for this measId and UE initiates the measurement reporting procedure.

If SCell state transition occurs (or if SSB transmission status of a SCell changes), UE performs measurement according to the new status.

For each serving cell for which servingCellMO is configured and of which SSB transmission status changes, UE performs followings:
if D1-SCell becomes D2-SCell at slot n+m1 of the SCell due to reception of DCI 2_10 at slot n of PCell;
   UE stops measuring SS/PBCH of the SCell at slot n+m4 of the SCell;
   UE stops deriving layer 3 filtered RSRP and RSRQ per beam for the SCell at slot n+m3 of the SCell;
   UE reset parameters related to layer 3 filtering for the SCell (e.g. initialize Mn, Fn and Fn−1 to zero);
   UE remove the SCell in one or more cellsTriggeredList (to prevent D2-SCell fulfilling leaving condition and triggering measurement report procedure).
if D2-SCell becomes D1-SCell at slot n+m2 of the SCell due to reception of DCI 2_10 at slot n of PCell;
   UE starts measuring SS/PBCH of the SCell at slot n+m5 of the SCell;
      slot n+m5 is the slot where the first SS/PBCH since #after slot n+m2 is transmitted in the SCell. It is determined based on SSB-ToMeasure in the ServingCellConfigCommon.
   UE starts deriving layer 3 filtered RSRP and RSRQ per beam for the SCell at slot n+m6 of the SCell;
      slot n+m6 is the slot when the first measurement result from the physical layer since #after slot n+m5 becomes available.
if D2-SCell becomes A-SCell at slot n+m6 of the SCell due to reception of MAC CE at slot n of PCell;
   UE starts measuring SS/PBCH of the SCell at slot n+m7 of the SCell;
      slot n+m7 is the slot where the first SS/PBCH since #after slot n+m6 is transmitted in the SCell. It is determined based on SSB-ToMeasure in the ServingCellConfigCommon.
   UE starts deriving layer 3 filtered RSRP and RSRQ per beam for the SCell at slot n+m7 of the SCell;
      slot n+m7 is the slot when the first measurement result from the physical layer since #after slot n+m6 becomes available.

For serving cell measurement, UE may perform followings.

At 4A10, UE receives an RRC message, wherein the RRC message comprises a serving cell configuration IE for a first serving cell.

At 4A20, UE performs measurement on synchronization signal of the first serving cell based on that:
the first serving cell is not a second type secondary cell [D2-SCell]; and
a first field [servingCellMO] is comprised in the serving cell configuration IE. At 4A30, UE performs measurement result report based on the measurement results on synchronization signal of the first serving cell.

The first field indicates a measurement object that is associated with the first serving cell.

The physical boradcast channel (PBCH) is:
periodically transmitted in a first type secondary cell; and
not transmitted (or transmitted with a longer periodicity) in the second type secondary cell.

UE determines that the first serving cell is the second type secondary cell in case that:
a field indicating no PBCH transmission is comprised in the serving cell configuration IE; or
a downlink information indicating no PBCH transmission for the first serving cell is received.

For measurement reporting (and for applicable cell determination), UE may perform followings.

At 4B10, UE receives a RRC message, wherein the RRC message comprises:
a measurement configuration IE; and
a serving cell configuration IE for a first serving cell.

At 4B20, UE determines based on the measurement configuration IE that a first measurement identity is associated with:
a first measurement object; and
a first report configuration.

At 4B30, UE determines that the first serving cell is associated with the first measurement object based on that:
a first field [servingCellMO] is comprised in the serving cell configuration IE for the first serving cell; and
the first field indicates the identity of the first measurement object.

At 4B40, UE determines whether the first serving cell is applicable for the first measurement identity based on:
a type of an event associated with the first measurement identity; and
a type of the first serving cell.

At 4B50, UE determines whether the entry condition for the event is fulfilled based on layer 3 filtered measurements of a one or more applicable cells for the first measurement identity.

At 4B60, UE triggers measurement report for the first measurement identity based on that the entry condition for the event is fulfilled for the one or more applicable cells.

The first serving cell is applicable in case that:
the event associated with the first measurement identity is a first type; or
the event associated with the first measurement identity is a second type and the first serving cell is not second type secondary serving cell.

The first serving cell is not applicable in case that:
the event associated with the first measurement identity is the second type; and
the first serving cell is second type secondary serving cell;

The first type event is an event related to only a specific serving cell.

The second type event is event related to a specific serving cell and a one or more neighbouring cells.

PBCH is periodically transmitted in a first type secondary cell.

PBCH is not transmitted in the second type secondary cell.

For a Synchronization Signal reception, UE may perform followings:

At 4C10, UE receives a RRC message, wherein the RRC message comprises a serving cell configuration IE for a first serving cell;

At 4C20, UE receives, in a downlink channel of a second serving cell [PCell], a control information based on a first RNTI and a common search space.

At 4C30, UE determines, based on a specific bit of the control information, whether to:
perform measurement on a synchronization signal of the first serving cell;
consider the layer 3 filtered measurement results of the SS of the first serving cell to determine whether to trigger measurement report; and
include the layer 3 filtered measurement results of the first serving cell in the measurement report;

At 4C40, UE performs measurement report procedure based on the determination.

The control information comprises one or more bits.

Each of the one or more bits is associated with a cell.

The association between the specific bit and the first serving cell is indicated in the RRC message.

UE performs measurement on the SS of the first serving cell in case that:
the specific bit of the control information is set to a first value; and
the SS of the first serving cell was not measured by the UE before the reception of the control information.

UE does not perform measurement on the SS of the first serving cell in case that:
the specific bit of the control information is set to a second value; and
the SS of the first serving cell was measured by the UE before the reception of the control information.

UE considers the layer 3 filtered measurement results of the SS of the first serving cell in triggering measurement report in case that:
the specific bit of the control information is set to a first value; and
the SS of the first serving cell was not measured by the UE before the reception of the control information.

UE does not consider the layer 3 filtered measurement results of the SS of the first serving cell in triggering measurement report in case that:
the specific bit of the control information is set to a second value; and
the SS of the first serving cell was measured by the UE before the reception of the control information.

UE includes the layer 3 filtered measurement results of the first serving cell in the measurement report in case that:
the specific bit of the control information is set to a first value; and
the SS of the first serving cell was not measured by the UE before the reception of the control information.

UE does not include the layer 3 filtered measurement results of the first serving cell in the measurement report in case that:
the specific bit of the control information is set to a second value; and
the SS of the first serving cell was measured by the UE before the reception of the control information.

UE performs followings:
receiving a radio resource control (RRC) message, wherein the RRC message comprises a set of configuration parameters for a secondary cell (Scell); and
starting a measurement on the SCell:
   at a first time point in case that the SCell is a first type SCell or a second type SCell; and
   at a second time point in case that the SCell is a third type SCell,
wherein the SCell is the first type SCell in case that the set of configuration parameters for the SCell:
   comprises a first parameter [SCell state]; and
   does not comprise a second parameter [SSB_OFF_INDICATION],
wherein the SCell is the second type SCell in case that the set of configuration parameters for the SCell:
   does not comprise the first parameter; and
   does not comprise the second parameter,
wherein the SCell is the third type SCell in case that the set of configuration parameters for the SCell:
   does not comprise the first parameter; and
   comprises the second parameter,
wherein:
   the first time point is determined based on time point when the RRC message is received; and
   the second time point is determined based on time point when a specific downlink information is received,
wherein:
   the specific downlink information comprises one or more bits; and
   a specific bit of the one or more bits corresponds to the SCell.

The first parameter is related to state of corresponding cell; and

The second parameter is related to transmission of a first set of downlink signals [PSS/SSS/PBCH] of corresponding cell.

The measurement on the SCell is performed based on discontinuous reception period in case that the SCell is the first type SCell; and

The measurement on the SCell is performed based on a measurement cycle in case that the SCell is the second type SCell.

The measurement cycle is determined based on a measurement cycle parameter; and

The measurement cycle parameter is determined based on a third parameter [servingCellMO] in the set of configuration parameters for the SCell.

The third parameter comprises an identifier;

The identifier indicates a set of measurement parameters; and The set of measurement parameters comprises the measurement cycle parameter.

The measurement on the SCell is performed on a second set of downlink signals [PSS/SSS];

The second set of downlink signals comprises a first synchronization signal and a second synchronization signal; and

The first set of downlink signals comprises the second set of downlink signals and a downlink signal on physical broadcast channel.

The first synchronization signal is transmitted in a first symbol;
The second synchronization signal is transmitted in a second symbol; and
The first symbol and the second symbol are apart by an interval of a symbol.

UE may perform followings based on SCell measurement:
initiating a measurement reporting procedure; and
transmitting a measurement report message.

The measurement report message comprises a parameter for measurement results on the SCell in case that:
the SCell is the first type SCell or the second type SCell; and
a third parameter is comprised in the set of configuration parameters for the SCell.

The measurement report message does not comprise the parameter for measurement results on the SCell in case that the SCell is the third type SCell.

The third parameter indicates a set of measurement parameters associated with the SCell.

The second time point is further determined based on a specific subcarrier spacing;
The specific subcarrier spacing is subcarrier spacing of a first cell; and
The first cell is not the Scell.

The second time point is further determined based on a slot where hybrid automatic retransmission request acknowledgement for the downlink control information is transmitted [D2-Scell→A-Scell].

Table 3 is ASN.1 of SCellConfig IE.

TABLE 3

| | |
|---|---|
| SCellConfig ::= | SEQUENCE { |
| sCellIndex | SCellIndex, |
| sCellConfigCommon | ServingCellConfigCommon |

OPTIONAL, -- Cond SCellAdd

| | |
|---|---|
| sCellConfigDedicated | ServingCellConfig |

```
OPTIONAL, -- Cond SCellAddMod
  ...,
  [[
```

| | |
|---|---|
| smtc | SSB-MTC |

```
OPTIONAL -- Need S
  ]],
  [[
```

| | |
|---|---|
| sCellState-r16 | ENUMERATED {activated} |

OPTIONAL, -- Cond SCellAddSync

| | |
|---|---|
| secondaryDRX-GroupConfig-r16 | ENUMERATED {true} |

```
OPTIONAL Cond DRX-Config2
  ]],
  [[
```

| | |
|---|---|
| preConfGapStatus-r17 | BIT STRING (SIZE (maxNrofGapId-r17)) |

OPTIONAL, -- Cond PreConfigMG
goodServingCellEvaluationBFD-r17 GoodServingCellEvaluation-r17
OPTIONAL, -- Need R

| | |
|---|---|
| sCellSIB20-r17 | SetupRelease { SCellSIB20-r17 } |

OPTIONAL -- Need M
]]

| | |
|---|---|
| SSB_OFF_INDICATION | ENUMERATED {disabled} |

}

sCellState field indicates whether the SCell shall be considered to be in activated state upon SCell configuration.

SSB_OFF_INDICATION field indicates whether the SSB transmission of SCell is disabled. If this field is absent, SSB transmission is enabled. If this field is present, SSB transmission is disabled.

Table 4 is ASN.1 of ServingCellConfig IE.

TABLE 4

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF BWP-Id |

OPTIONAL, -- Need N

| | |
|---|---|
| downlinkBWP-ToAddModList | SEQUENCE (SIZE (1..maxNrofBWPs)) OF BWP-Downlink |

OPTIONAL, -- Need N

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, ms6, ms8, ms10, |

ms20, ms30,

ms40, ms50, ms60, ms80, ms100,

ms200, ms300, ms500,

ms750, ms1280, ms1920, ms2560, spare10,

spare9, spare8,

spare7, spare6, spare5, spare4, spare3,

spare2, spare1 } OPTIONAL, -- Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, ms200, ms240, |
| | ms320, ms400, ms480, ms520, ms640, |

ms720,

ms840, ms1280, spare2, spare1}

OPTIONAL, -- Cond ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy1 | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

OPTIONAL, -- Cond MeasObject
...,

servingCellMO field indicates measObjectId of the MeasObjectNR in MeasConfig which is associated to the serving cell. Based on this field, UE determines measurement object to be measured for serving cell measurement.

5 Table 5 is ASN.1 of MeasConfig IE.

TABLE 5

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

OPTIONAL -- Need R
]]
}

| | |
|---|---|
| MeasObjectToRemoveList :: = | SEQUENCE (SIZE (1..maxNrofObjectId)) OF |

MeasObjectId

| | |
|---|---|
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

Table 6 is ASN.1 of MeasIdToAddModList IE.

TABLE 6
-- ASN1START
-- TAG-MEASIDTOADDMODLIST-START

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}
-- TAG-MEASIDTOADDMODLIST-STOP
-- ASN1STOP

For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

Table 7 is ASN.1 of MeasObjectToAddModList IE.

TABLE 7
-- ASN1START
-- TAG-MEASOBJECTTOADDMODLIST-START

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |
| ..., | MeasObjectEUTRA, |

measObjectEUTRA

| | |
|---|---|
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |

}
}
-- TAG-MEASOBJECTTOADDMODLIST-STOP
--ASN1STOP

Measurement object is an objects on which the UE shall perform the measurements.

For intra-frequency and inter-frequency measurements a measurement object indicates the frequency/time location and subcarrier spacing of reference signals to be measured.

The measObjectId of the MO which corresponds to each serving cell is indicated by servingCellMO within the serving cell configuration.

Table 8 is ASN.1 of MeasObjectNR IE.

TABLE 8
-- ASN1START
-- TAG-MEASOBJECTNR-START

| | |
|---|---|
| MeasObjectNR ::= | SEQUENCE { |
| ssbFrequency | ARFCN-ValueNR |
| OPTIONAL, -- Cond SSBorAssociatedSSB | SubcarrierSpacing |

ssbSubcarrierSpacing

| | |
|---|---|
| OPTIONAL, -- Cond SSBorAssociatedSSB | SSB-MTC |

smtc1
OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| excludedCellsToRemoveList | PCI-RangeIndexList |

OPTIONAL, -- Need N

| | |
|---|---|
| excludedCellsToAddModList | SEQUENCE (SIZE (1..maxNrofPCI-Ranges)) OF PCI- |

RangeElement OPTIONAL, -- Need N

| | |
|---|---|
| allowedCellsToRemoveList | PCI-RangeIndexList |

OPTIONAL, -- Need N

| | |
|---|---|
| allowedCellsToAddModList | SEQUENCE (SIZE (1..maxNrofPCI-Ranges)) OF PCI- |

```
RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, |

```
sf1024, sf1280} OPTIONAL -- Need
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
  ]],
  [[
...
```

| | |
|---|---|
| CellsToAddModList ::= | SEQUENCE (SIZE (1..maxNrofCellMeas)) OF CellsToAddMod |
| CellsToAddModListExt-v1710 ::= | SEQUENCE (SIZE (1..maxNrofCellMeas)) OF |

CellsToAddModExt-v1710

| | |
|---|---|
| CellsToAddMod ::= | SEQUENCE { |
| physCellId | PhysCellId, |
| cellIndividualOffset | Q-OffsetRangeList |

}

allowedCellsToAddModList field indicates List of cells to add/modify in the allow-list of cells. It applies only to SSB resources.

allowedCellsToRemoveList field indicates List of cells to remove from the allow-list of cells.

excludedCellsToAddModList field indicates List of cells to add/modify in the exclude-list of cells.

excludedCellsToRemoveList field indicates List of cells to remove from the exclude-list of cells.

ssbFrequency field indicates the frequency of the SS associated to this MeasObjectNR.

Table 9 is ASN.1 of ReportConfigToAddModList IE.

TABLE 9
-- ASN1 START
-- TAG-REPORTCONFIGTOADDMODLIST-START

| | |
|---|---|
| ReportConfigToAddModList ::= | SEQUENCE (SIZE (1..maxReportConfigId)) OF |

ReportConfigToAddMod

| | |
|---|---|
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16 |

}
}
-- TAG-REPORTCONFIGTOADDMODLIST-STOP
-- ASN1STOP

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.
Event A1 refers to the event where Serving becomes better than absolute threshold;
Event A2 refers to the event where Serving becomes worse than absolute threshold;
Event A3 refers to the event where Neighbour becomes amount of offset better than PCell/PSCell;
Event A4 refers to the event where Neighbour becomes better than absolute threshold;
Event A5 refers to the event where PCell/PSCell becomes worse than absolute threshold1 AND Neighbour/SCell becomes better than another absolute threshold2;
Event A6 refers to the event where Neighbour becomes amount of offset better than SCell.

Table 10 is ASN.1 of ReportConfigNR IE.

TABLE 10

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17 |

}
}

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER (1.. 65525), |
| distanceThreshFromReference2-r17 | INTEGER (1.. 65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]]
  },
```

| | |
|---|---|
| rsType | NR-RS-Type, |
| reportInterval | ReportInterval, |
| reportAmount | ENUMERATED {r1, r2, r4, r8, r16, r32, r64, |

infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport ) |

OPTIONAL, -- Need R

| | |
|---|---|
| includeBeamMeasurements | BOOLEAN, |
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
}

| | |
|---|---|
| MeasTriggerQuantity ::= | CHOICE { |
| rsrp | RSRP-Range, |
| rsrq | RSRQ-Range, |
| sinr | SINR-Range |

}

| | |
|---|---|
| MeasTriggerQuantityOffset ::= | CHOICE { |
| rsrp | INTEGER (−30..30), |
| rsrq | INTEGER (−30..30), |
| sinr | INTEGER (−30..30) |

}

| | |
|---|---|
| MeasReportQuantity ::= | SEQUENCE { |
| rsrp | BOOLEAN, |
| rsrq | BOOLEAN, |
| sinr | BOOLEAN |

}

a3-Offset/a6-Offset field indicates Offset value(s) to be used in NR measurement report triggering condition for event a3/a6. The actual value is field value*0.5 dB.

aN-ThresholdM field indicates Threshold value associated to the selected trigger quantity (e.g. RSRP, RSRQ, SINR) per RS Type (e.g. SS/PBCH block, CSI-RS) to be used in NR measurement report triggering condition for event number aN.

eventId field comprises a Choice of NR event triggered reporting criteria.

maxNrofRS-IndexesToReport field indicates Max number of RS indexes to include in the measurement report for A1-A6 events.

maxReportCells field indicates Max number of non-serving cells to include in the measurement report.

reportOnLeave field indicates whether or not the UE shall initiate the measurement reporting procedure when the leaving condition is met for a cell in cellsTriggeredList.

reportQuantityCell field indicates the cell measurement quantities to be included in the measurement report.

reportQuantityRS-Indexes field indicates which measurement information per RS index the UE shall include in the measurement report.

timeToTrigger field indicates time during which specific criteria for the event needs to be met in order to trigger a measurement report.

useAllowedCellList field indicates whether only the cells included in the allow-list of the associated measObject are applicable.

For use T312 field, if value TRUE is configured, the UE shall use the timer T312 with the value t312 as specified in the corresponding measObjectNR. If value FALSE is configured, the timer T312 is considered as disabled. Network configures value TRUE only if reportType is set to eventTriggered.

xN-ThresholdM field indicates threshold value associated to the selected trigger quantity (e.g. RSRP, RSRQ, SINR) per RS Type (e.g. SS/PBCH block, CSI-RS) to be used in NR measurement report triggering condition for event xN. If multiple thresholds are defined for event number xN, the thresholds are differentiated by M. x1-Threshold1 and x2-Threshold indicates the threshold value for the serving L2 U2N Relay UE, x1-Threshold2 indicates the threshold value for the NR Cells.

The cellsTriggeredList serves as a mechanism for tracking cells that have met specific measurement event criteria. It is used by mobile terminals (UEs) to manage and report on cells that have triggered measurement events. Based on this list, UE prevent duplicate measurement report to be sent.

The cellsTriggeredList is managed per measId (measurement identity). UE includes into the list physical cell identity of the cell for which entering (entry) condition is met.

UE removes from the list physical cell identity of the cell:
for which leaving condition is met; and
that is included in the list.

UE removes from the list physical cell identity of the cell:
of which cell state changes from A-Scell/D1-SCell to D2-Scell; and
that is included in the list.

UE initiates the measurement reporting procedure in case that:
a cell is included in the list; or
a cell is removed from the list due to meeting leaving condition.

UE does not initiate the measurement reporting procedure upon change of the list (addition/removal) in case that the change is caused by cell state change.

The MeasurementReport message is used for the indication of measurement results. The MeasurementReport message comprises MeasResults IE. The IE MeasResults covers measured results for intra-frequency, inter-frequency, inter-RAT mobility and measured results for NR sidelink communication/discovery.

Table 10 is ASN.1 of MeasResults IE.

TABLE 10
-- ASN1START
-- TAG-MEASRESULTS-START

| | |
|---|---|
| MeasResults ::= | SEQUENCE { |
| measId | MeasId, |
| measResultServingMOList | MeasResultServMOList, |

-- contains measurement results of specific serving cells (e.g. PCell and specific SCells)

| measResultNeighCells | CHOICE { | |
|---|---|---|
| measResultListNR | MeasResultListNR, | |
| ..., | | |
| measResultListEUTRA | MeasResultListEUTRA, | |
| measResultListUTRA-FDD-r16 | MeasResultListUTRA-FDD-r16, | |
| sl-MeasResultsCandRelay-r17 | OCTET STRING | -- Contains PC5 SL- |
| MeasResultListRelay-r17 | | |
| } | | |
| OPTIONAL, | | |
| ..., | | |
| [[ | | |
| measResultServFreqListEUTRA-SCG | | MeasResultServFreqListEUTRA-SCG |
| OPTIONAL, | | |
| measResultServFreqListNR-SCG | | MeasResultServFreqListNR-SCG |
| OPTIONAL, | | |
| measResultSETD-EUTRA | | MeasResultSFTD-EUTRA |
| OPTIONAL, | | |
| measResultSETD-NR | | MeasResultCellSFTD-NR |
| OPTIONAL | | |
| ]], | | |
| [[ | | |
| measResultCellListSFTD-NR | | MeasResultCellListSFTD-NR |
| OPTIONAL | | |
| ]], | | |
| [[ | | |
| measResultForRSSI-r16 | | MeasResult ForRSSI-r16 |
| OPTIONAL, | | |
| locationInfo-r16 | | LocationInfo-r16 |
| OPTIONAL, | | |
| ul-PDCP-DelayValueResultList-r16 | | UL-PDCP-DelayValueResultList-r16 |
| OPTIONAL, | | |
| measResultsSL-r16 | | MeasResultsSL-r16 |
| OPTIONAL, | | |
| measResultCLI-r16 | | MeasResultCLI-r16 |
| OPTIONAL | | |
| ]], | | |
| [[ | | |
| measResultRxTxTimeDiff-r17 | | MeasResultRxTxTimeDiff-r17 |
| OPTIONAL, | | |
| sl-MeasResultServingRelay-r17 | | OCTET STRING |
| OPTIONAL, | | |
| -- Contains PC5 SL-MeasResultRelay-r17 | | UL-PDCP-ExcessDelayResultList-r17 |
| ul-PDCP-ExcessDelayResultList-r17 | | |
| OPTIONAL, | | |
| coarseLocationInfo-r17 | | OCTET STRING |
| OPTIONAL | | |
| ]] | | |
| } | | |
| MeasResultServMOList ::= | | SEQUENCE (SIZE (1..maxNrofServingCells)) OF |
| MeasResultServMO | | |
| MeasResultServMO ::= | SEQUENCE { | |
| servCellId | ServCellIndex, | |
| measResultServingCell | MeasResultNR, | |
| measResultBestNeighCell | | MeasResultNR |
| OPTIONAL, | | |
| ... | | |
| } | | |
| MeasResultListNR ::= | SEQUENCE (SIZE (1..maxCellReport)) OF MeasResultNR | |
| MeasResultNR :: = | SEQUENCE { | |
| physCellId | | PhysCellId |
| OPTIONAL, | | |
| measResult | SEQUENCE { | |
| cellResults | SEQUENCE { | |
| resultsSSB-Cell | | MeasQuantityResults |
| OPTIONAL, | | |
| resultsCSI-RS-Cell | | MeasQuantityResults |
| OPTIONAL | | |
| }, | | |
| rsIndexResults | SEQUENCE { | |
| resultsSSB-Indexes | | ResultsPerSSB-IndexList |
| OPTIONAL, | | |
| resultsCSI-RS-Indexes | | ResultsPerCSI-RS-IndexList |
| OPTIONAL | | |
| } | | |
| OPTIONAL | | |
| }, | | |
| ..., | | |
| [[ | | |
| cgi-Info | | CGI-InfoNR |
| OPTIONAL | | |
| ]] , | | |
| [[ | | |
| choCandidate-r17 | | ENUMERATED {true} |
| OPTIONAL, | | |
| choConfig-r17 | | SEQUENCE (SIZE (1..2)) OF CondTriggerConfig- |
| r16 | OPTIONAL, | |
| triggeredEvent-r17 | SEQUENCE { | |
| timeBetweenEvents-r17 | | TimeBetweenEvent-r17 |
| OPTIONAL, | | |
| firstTriggeredEvent | | ENUMERATED {condFirstEvent, |
| condSecondEvent} | OPTIONAL | |
| } | | |
| OPTIONAL | | |
| ]] | | |
| } | | |
| MeasResultListEUTRA ::= | | SEQUENCE (SIZE(1..maxCellReport)) OF |
| MeasResultEUTRA | | |
| MeasResultEUTRA ::= | SEQUENCE { | |
| eutra-PhysCellId | PhysCellId, | |
| measResult | MeasQuantityResultsEUTRA, | |
| cgi-Info | | CGI-InfoEUTRA |
| OPTIONAL, | | |
| ... | | |
| } | | |
| MultiBandInfoListEUTRA ::= | | SEQUENCE (SIZE(1..maxMultiBands)) OF |
| FreqBandIndicatorEUTRA | | |
| MeasQuantityResults ::= | SEQUENCE { | |
| rsrp | | RSRP-Range |
| OPTIONAL, | | |
| rsrq | | RSRQ-Range |
| OPTIONAL, | | |
| sinr | | SINR-Range |
| OPTIONAL | | |
| } | | |
| MeasQuantityResultsEUTRA ::= | SEQUENCE { | |
| rsrp | | RSRP-RangeEUTRA |
| OPTIONAL, | | |
| rsrq | | RSRQ-RangeEUTRA |
| OPTIONAL, | | |
| sinr | | SINR-RangeEUTRA |
| OPTIONAL | | |
| } | | |
| ResultsPerSSB-IndexList ::= | | SEQUENCE (SIZE (1..maxNrofIndexesToReport2)) OF |
| Results PerSSB-Index | | |
| ResultsPerSSB-Index ::= | SEQUENCE { | |
| ssb-Index | SSB-Index, | |
| ssb-Results | | MeasQuantityResults |
| OPTIONAL | | |
| } | | |
| ResultsPerCSI-RS-IndexList::= | | SEQUENCE (SIZE (1..maxNrofIndexesToReport2)) OF |
| ResultsPerCSI-RS-Index | | |
| ResultsPerCSI-RS-Index ::= | SEQUENCE { | |
| csi-RS-Index | CSI-RS-Index, | |

| | |
|---|---|
| csi-RS-Results | MeasQuantityResults |
| OPTIONAL | |
| } | |

MeasResultServFreqListEUTRA-SCG ::= SEQUENCE (SIZE (1..maxNrofServingCellsEUTRA)) OF

MeasResult2EUTRA

MeasResultServFreqListNR-SCG ::= SEQUENCE (SIZE (1..maxNrofServingCells)) OF MeasResult2NR

| MeasResultListUTRA-FDD-r16 ::= | | SEQUENCE (SIZE (1..maxCellReport )) OF |
|---|---|---|
| MeasResultUTRA-FDD-r16 | | |
| MeasResultUTRA-FDD-r16 ::= | SEQUENCE { | |
| physCellId-r16 | PhysCellIdUTRA-FDD-r16, | |
| measResult-r16 | SEQUENCE { | |
| utra-FDD-RSCP-r16 | INTEGER (−5..91) | OPTIONAL, |
| utra-FDD-EcN0-r16 | INTEGER (0..49) | OPTIONAL |
| } | | |
| } | | |
| MeasResultForRSSI-r16 ::= | SEQUENCE { | |
| rssi-Result-r16 | RSSI-Range-r16, | |
| channelOccupancy-r16 | INTEGER (0..100) | |
| } | | |
| MeasResultCLI-r16 ::= | SEQUENCE { | |
| measResultListSRS-RSRP-r16 | | MeasResultListSRS-RSRP-r16 |
| OPTIONAL, | | |
| measResultListCLI-RSSI-r16 | | MeasResultListCLI-RSSI-r16 |
| OPTIONAL | | |
| } | | |
| MeasResultListSRS-RSRP-r16 ::= | SEQUENCE (SIZE (1..maxCLI-Report-r16)) OF MeasResultSRS- | |
| RSRP-r16 | | |
| MeasResultSRS-RSRP-r16 ::= | SEQUENCE { | |
| srs-ResourceId-r16 | SRS-ResourceId, | |
| srs-RSRP-Result-r16 | SRS-RSRP-Range-r16 | |
| } | | |
| MeasResultListCLI-RSSI-r16 ::= | SEQUENCE (SIZE (1..maxCLI-Report-r16)) OF MeasResultCLI- | |
| RSSI-r16 | | |
| MeasResultCLI-RSSI-r16 ::= | SEQUENCE { | |
| rssi-ResourceId-r16 | RSSI-ResourceId-r16, | |
| cli-RSSI-Result-r16 | CLI-RSSI-Range-r16 | |
| } | | |
| UL-PDCP-DelayValueResultList-r16 :: = SEQUENCE (SIZE (1..maxDRB)) OF UL-PDCP- | | |
| DelayValueResult-r16 | | |
| UL-PDCP-DelayValueResult-r16 ::= SEQUENCE { | | |
| drb-Id-r16 | DRB-Identity, | |
| averageDelay-r16 | INTEGER (0..10000), | |
| ... | | |
| } | | |
| UL-PDCP-ExcessDelayResultList-r17 :: = SEQUENCE (SIZE (1..maxDRB)) OF UL-PDCP- | | |
| ExcessDelayResult-r17 | | |
| UL-PDCP-ExcessDelayResult-r17 ::= SEQUENCE { | | |
| drb-Id-r17 | DRB-Identity, | |
| excessDelay-r17 | INTEGER (0..31), | |

...
}
TimeBetweenEvent-r17 ::= INTEGER (0..1023)
-- TAG-MEASRESULTS-STOP
-- ASN1STOP

MeasResultNR IE comprises following fields

cellResults field indicates cell level measurement results.

locationInfo field indicates positioning related information and measurements.

physCellId field indicates the physical cell identity of the NR cell for which the reporting is being performed.

resultsSSB-Cell field indicates cell level measurement results based on SS/PBCH related measurements.

resultsSSB-Indexes field indicates beam level measurement results based on SS/PBCH related measurements.

resultsCSI-RS-Cell field indicates cell level measurement results based on CSI-RS related measurements.

resultsCSI-RS-Indexes field indicates beam level measurement results based on CSI-RS related measurements.

rsIndexResults field indicates beam level measurement results.

coarseLocationInfo field indicates the coarse location information reported by the UE.

measId field indicates identifies the measurement identity for which the reporting is being performed.

measQuantityResults field indicates the measurement result.

measResultListEUTRA field comprises list of measured results for the maximum number of reported best cells for an E-UTRA measurement identity.

measResultListNR field comprises list of measured results for the maximum number of reported best cells for an NR measurement identity.

measResultListUTRA-FDD field comprises list of measured results for the maximum number of reported best cells for a UTRA-FDD measurement identity.

measResultNR field comprises measured results of an NR cell.

measResultServingMOList field comprises measured results of measured cells with reference signals indicated in the serving cell measurement objects. This field includes measurement results of SpCell, configured SCell(s) and best neighbouring cell.

SS reference signal received power (SS-RSRP) is defined as the linear average over the power contributions (in [W]) of the resource elements that carry secondary synchronization signals. The measurement time resource(s) for SS-RSRP are confined within SS/PBCH Block Measurement Time Configuration (SMTC) window duration.

For SS-RSRP determination demodulation reference signals for physical broadcast channel (PBCH) and, if indicated by higher layers, CSI reference signals in addition to secondary synchronization signals may be used. SS-RSRP using demodulation reference signal for PBCH or CSI reference signal shall be measured by linear averaging over the power contributions of the resource elements that carry corresponding reference signals taking into account power scaling for the reference signals. If SS-RSRP is not used for L1-RSRP, the additional use of CSI reference signals for SS-RSRP determination is not applicable.

SS-RSRP shall be measured only among the reference signals corresponding to SS/PBCH blocks with the same SS/PBCH block index and the same physical-layer cell identity.

If SS-RSRP is not used for L1-RSRP and higher-layers indicate certain SS/PBCH blocks for performing SS-RSRP measurements, then SS-RSRP is measured only from the indicated set of SS/PBCH block(s).

A Serving Cell may be configured with one or multiple BWPs. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signalling, or by the UE itself upon initiation of Random Access procedure or upon detection of consistent LBT failure on SpCell. Upon RRC (re-)configuration of firstActiveDownlinkBWP-Id and/or firstActiveUplinkBWP-Id for SpCell except for PSCell when SCG is deactivated or activation of an SCell, the DL BWP and/or UL BWP indicated by firstActiveDownlinkBWP-Id and/or firstActiveUplinkBWP-Id respectively is active without receiving PDCCH indicating a downlink assignment or an uplink grant. Upon RRC (re-)configuration of firstActiveDownlinkBWP-Id for PSCell when SCG is deactivated, the DL BWP is switched to the firstActiveDownlinkBWP-Id. The active BWP for a Serving Cell is indicated by either RRC or PDCCH. For unpaired spectrum, a DL BWP is paired with a UL BWP, and BWP switching is common for both UL and DL.

For each activated Serving Cell configured with a BWP, the UE shall:
if a BWP is activated and the active DL BWP for the Serving Cell is not the dormant BWP and the Serving Cell is not the PSCell of deactivated SCG:
   transmit on UL-SCH on the BWP;
   transmit on RACH on the BWP, if PRACH occasions are configured;
   monitor the PDCCH on the BWP;
   transmit PUCCH on the BWP, if configured;
   report CSI for the BWP;
   transmit SRS on the BWP, if configured;
   receive DL-SCH on the BWP;
   (re-)initialize any suspended configured uplink grants of configured grant Type 1 on the active BWP according to the stored configuration, if any, and to start in the symbol according to predefined rules;
   if lbt-FailureRecoveryConfig is configured:
      stop the lbt-FailureDetection Timer, if running;
      set LBT COUNTER to 0;
      monitor LBT failure indications from lower layers.
if a BWP is activated and the active DL BWP for the Serving Cell is dormant BWP:
   stop the bwp-Inactivity Timer of this Serving Cell, if running.
   not monitor the PDCCH on the BWP;
   not monitor the PDCCH for the BWP;
   not receive DL-SCH on the BWP;
   not report CSI on the BWP, report CSI except aperiodic CSI for the BWP;
   not transmit SRS on the BWP;
   not transmit on UL-SCH on the BWP;
   not transmit on RACH on the BWP;
   not transmit PUCCH on the BWP;
   clear any configured downlink assignment and any configured uplink grant Type 2 associated with the SCell respectively;
   suspend any configured uplink grant Type 1 associated with the SCell;
   if configured, perform beam failure detection and beam failure recovery for the SCell if beam failure is detected.
if a BWP is deactivated or the Serving Cell is PSCell of deactivated SCG:
   not transmit on UL-SCH on the BWP;
   not transmit on RACH on the BWP;
   not monitor the PDCCH on the BWP;
   not transmit PUCCH on the BWP;
   not report CSI for the BWP;
   not transmit SRS on the BWP;
   not receive DL-SCH on the BWP;
   clear any configured downlink assignment and configured uplink grant of configured grant Type 2 on the BWP;
   suspend any configured uplink grant of configured grant Type 1 on the inactive BWP.

Upon initiation of the Random Access procedure on a Serving Cell, after the selection of carrier for performing Random Access procedure, the UE shall for the selected carrier of this Serving Cell:
if PRACH occasions are not configured for the active UL BWP:
   if the UE is a RedCap UE; and
   if initialUplinkBWP-RedCap is configured:
      switch the active UL BWP to BWP indicated by initialUplinkBWP-RedCap.
   else:
      switch the active UL BWP to BWP indicated by initialUplinkBWP.
   if the Serving Cell is an SpCell:
      if the UE is a RedCap UE; and
      if initialDownlinkBWP-RedCap is configured:
         switch the active DL BWP to BWP indicated by initialDownlinkBWP-RedCap.
      else:
         switch the active DL BWP to BWP indicated by initialDownlinkBWP.
else:
   if the Serving Cell is an SpCell:
      if the active DL BWP does not have the same bwp-Id as the active UL BWP:
         switch the active DL BWP to the DL BWP with the same bwp-Id as the active UL BWP.
stop the bwp-InactivityTimer associated with the active DL BWP of this Serving Cell, if running.
if the Serving Cell is SCell:
   stop the bwp-InactivityTimer associated with the active DL BWP of SpCell, if running.
perform the Random Access procedure on the active DL BWP of SpCell and active UL BWP of this Serving Cell.

If the UE receives a PDCCH for BWP switching of a Serving Cell, the UE shall:
if there is no ongoing Random Access procedure associated with this Serving Cell; or
if the ongoing Random Access procedure associated with this Serving Cell is successfully completed upon reception of this PDCCH addressed to C-RNTI:
   cancel, if any, triggered consistent LBT failure for this Serving Cell;
   perform BWP switching to a BWP indicated by the PDCCH.

If the UE receives a PDCCH for BWP switching for a Serving Cell(s) or a dormancy SCell group(s) while a Random Access procedure associated with that Serving Cell is ongoing in the UE, it is up to UE implementation whether to switch BWP or ignore the PDCCH for BWP switching, except for the PDCCH reception for BWP switching addressed to the C-RNTI for successful Random Access procedure completion in which case the UE shall perform BWP switching to a BWP indicated by the PDCCH. Upon reception of the PDCCH for BWP switching other than successful contention resolution, if the UE decides to perform BWP switching, the UE shall stop the ongoing Random Access procedure and initiate a Random Access procedure after performing the BWP switching; if the MAC decides to ignore the PDCCH for BWP switching, the UE shall continue with the ongoing Random Access procedure on the Serving Cell.

Upon reception of RRC (re-)configuration for BWP switching for a Serving Cell while a Random Access procedure associated with that Serving Cell is ongoing in the UE, the UE shall stop the ongoing Random Access procedure and initiate a Random Access procedure after performing the BWP switching.

Upon reception of RRC (re-)configuration for BWP switching for a Serving Cell, cancel any triggered consistent LBT failure in this Serving Cell.

The UE shall for each activated Serving Cell configured with bwp-Inactivity Timer:
if the defaultDownlinkBWP-Id is configured, and the active DL BWP is not the BWP indicated by the defaultDownlinkBWP-Id, and the active DL BWP is not the BWP indicated by the dormantBWP-Id if configured; or
if the UE is not a RedCap UE, and if the defaultDownlinkBWP-Id is not configured, and the active DL BWP is not the initialDownlinkBWP, and the active DL BWP is not the BWP indicated by the dormantBWP-Id if configured; or
if the UE is a RedCap UE, and if the defaultDownlinkBWP-Id is not configured, and initialDownlinkBWP-RedCap is not configured, and the active DL BWP is not the initialDownlinkBWP; or
if the UE is a RedCap UE, and if the defaultDownlinkBWP-Id is not configured, and initialDownlinkBWP-RedCap is configured, and the active DL BWP is not the initialDownlinkBWP-RedCap:
   if a PDCCH addressed to C-RNTI or CS-RNTI indicating downlink assignment or uplink grant is received on the active BWP; or
   if a PDCCH addressed to G-RNTI or G-CS-RNTI configured for multicast indicating downlink assignment is received on the active BWP; or
   if a PDCCH addressed to C-RNTI or CS-RNTI indicating downlink assignment or uplink grant is received for the active BWP; or
   if a MAC PDU is transmitted in a configured uplink grant and LBT failure indication is not received from lower layers; or
   if a MAC PDU is received in a configured downlink assignment for unicast or MBS multicast:
      if there is no ongoing Random Access procedure associated with this Serving Cell; or
      if the ongoing Random Access procedure associated with this Serving Cell is successfully completed upon reception of this PDCCH addressed to C-RNTI:
         start or restart the bwp-Inactivity Timer associated with the active DL BWP.
   if the bwp-Inactivity Timer associated with the active DL BWP expires:
      if the defaultDownlinkBWP-Id is configured:
         perform BWP switching to a BWP indicated by the defaultDownlinkBWP-Id.
      else:
         if the UE is a RedCap UE; and
         if initialDownlinkBWP-RedCap is configured:
5> perform BWP switching to the initialDownlinkBWP-RedCap.
   else:
5> perform BWP switching to the initialDownlinkBWP.
if a PDCCH for BWP switching is received, and the UE switches the active DL BWP:
   if the defaultDownlinkBWP-Id is configured, and the UE switches to the DL BWP which is not indicated by the defaultDownlinkBWP-Id and is not indicated by the dormantBWP-Id if configured; or
   if the UE is not a RedCap UE, and if the defaultDownlinkBWP-Id is not configured, and the UE switches to the DL BWP which is not the initialDownlinkBWP and is not indicated by the dormantBWP-Id if configured; or
   if the UE is a RedCap UE, and if the defaultDownlinkBWP-Id is not configured, and initialDownlinkBWP-RedCap is not configured, and the UE switches to the DL BWP which is not the initialDownlinkBWP; or
   if the UE is a RedCap UE, and if the defaultDownlinkBWP-Id is not configured, and initialDownlinkBWP-RedCap is configured, and the UE switches to the DL BWP which is not the initialDownlinkBWP-RedCap:
      start or restart the bwp-Inactivity Timer associated with the active DL BWP.

Upon initiation of the Random Access procedure, after selection of the carrier for performing Random Access procedure if the UE is a RedCap UE in RRC_IDLE or RRC_INACTIVE mode, the UE shall:
if initialUplinkBWP-RedCap is configured for the selected carrier:
   perform the Random Access procedure by using the BWP configured by initialUplinkBWP-RedCap.
else:
   perform the Random Access procedure by using the BWP configured by initialUplinkBWP.
if initialDownlinkBWP-RedCap is configured:
   if the Random Access procedure was initiated for SI request and the Random Access Resources for SI request have been explicitly provided by RRC, and if the selected carrier is SUL carrier:
      monitor the PDCCH on the BWP configured by initialDownlinkBWP.
   else:
      monitor the PDCCH on the BWP configured by initialDownlinkBWP-RedCap.
else:
   monitor the PDCCH on the BWP configured by initialDownlinkBWP.

If the MAC entity is configured with one or more SCells, the network may activate and deactivate the configured SCells. Upon configuration of an SCell, the SCell is deactivated unless the parameter sCellState is set to activated for the SCell by upper layers.

The configured SCell(s) is activated and deactivated by:
receiving the SCell Activation/Deactivation MAC CE;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration;
receiving scg-State: the SCells of SCG are deactivated.

The MAC entity shall for each configured SCell:
if an SCell is configured with sCellState set to activated upon SCell configuration, or an SCell Activation/Deactivation MAC CE or an Enhanced SCell Activation/Deactivation MAC CE is received activating the SCell:
   if the SCell was deactivated prior to receiving this Enhanced SCell Activation/Deactivation MAC CE and a TRS is indicated for this SCell:
      indicate to lower layers the information regarding the TRS.
   if the SCell was deactivated prior to receiving this SCell Activation/Deactivation MAC CE or this Enhanced SCell Activation/Deactivation MAC CE; or
   if the SCell is configured with sCellState set to activated upon SCell configuration:
      if firstActiveDownlinkBWP-Id is not set to dormant BWP:
         activate the SCell according to the timing for MAC CE activation and according to the timing for direct SCell activation; i.e. apply normal SCell operation including:
         SRS transmissions on the SCell;
         CSI reporting for the SCell;
         PDCCH monitoring on the SCell;
         PDCCH monitoring for the SCell;
         PUCCH transmissions on the SCell, if configured.
      else (i.e. firstActiveDownlinkBWP-Id is set to dormant BWP):
         stop the bwp-Inactivity Timer of this Serving Cell, if running.
      activate the DL BWP and UL BWP indicated by firstActiveDownlinkBWP-Id and firstActiveUplinkBWP-Id respectively.
   start or restart the sCellDeactivationTimer associated with the SCell according to the timing for MAC CE activation and according to the timing for direct SCell activation;
   if the active DL BWP is not the dormant BWP:
      (re-)initialize any suspended configured uplink grants of configured grant Type 1 associated with this SCell according to the stored configuration, if any, and to start in the symbol according to rules;
      trigger PHR.
else if an SCell Activation/Deactivation MAC CE or an Enhanced SCell Activation/Deactivation MAC CE is received deactivating the SCell; or
if the sCellDeactivationTimer associated with the activated SCell expires; or
if the SCG associated with the activated SCell is deactivated:
   deactivate the SCell according to the timing;
   stop the sCellDeactivation Timer associated with the SCell;
   stop the bwp-Inactivity Timer associated with the SCell;
   deactivate any active BWP associated with the SCell;
   clear any configured downlink assignment and any configured uplink grant Type 2 associated with the SCell respectively;
   clear any PUSCH resource for semi-persistent CSI reporting associated with the SCell;
   suspend any configured uplink grant Type 1 associated with the SCell;
   flush all HARQ buffers associated with the SCell;
   cancel, if any, triggered consistent LBT failure for the SCell.
if PDCCH on the activated SCell indicates an uplink grant or downlink assignment; or
if PDCCH on the Serving Cell scheduling the activated SCell indicates an uplink grant or a downlink assignment for the activated SCell; or
if a MAC PDU is transmitted in a configured uplink grant and LBT failure indication is not received from lower layers; or
if a MAC PDU is received in a configured downlink assignment:
   restart the sCellDeactivation Timer associated with the SCell.
if the SCell is deactivated:
   not transmit SRS on the SCell;
   not report CSI for the SCell;
   not transmit on UL-SCH on the SCell;
   not transmit on RACH on the SCell;
   not monitor the PDCCH on the SCell;
   not monitor the PDCCH for the SCell;
   not transmit PUCCH on the SCell.

HARQ feedback for the MAC PDU containing SCell Activation/Deactivation MAC CE or Enhanced SCell Activation/Deactivation MAC CE shall not be impacted by PCell, PSCell and PUCCH SCell interruptions due to SCell activation/deactivation

When SCell is deactivated, the ongoing Random Access procedure on the SCell, if any, is aborted.

The SCell Activation/Deactivation MAC CE of one octet is identified by a MAC subheader with LCID. It has a fixed size and consists of a single octet containing seven C-fields and one R-field. The SCell Activation/Deactivation MAC CE with one octet is defined.

The SCell Activation/Deactivation MAC CE of four octets is identified by a MAC subheader with LCID. It has a fixed size and consists of four octets containing 31 C-fields and one R-field. The SCell Activation/Deactivation MAC CE of four octets is defined as follows
Cᵢ: If there is an SCell configured for the MAC entity with SCellIndex i this field indicates the activation/deactivation status of the SCell with SCellIndex i, else the MAC entity shall ignore the Cᵢ field. The Cᵢ field is set to 1 to indicate that the SCell with SCellIndex i shall be activated. The Cᵢ field is set to 0 to indicate that the SCell with SCellIndex i shall be deactivated;
R: Reserved bit, set to 0.

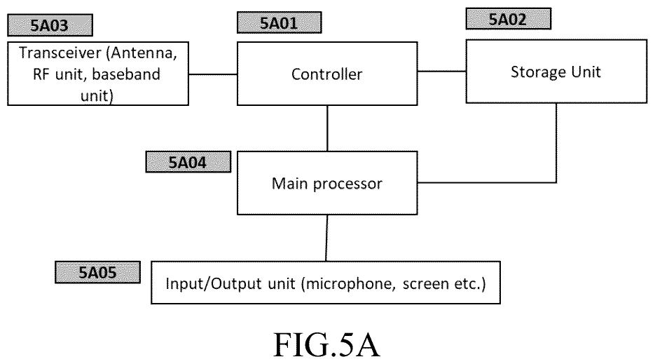

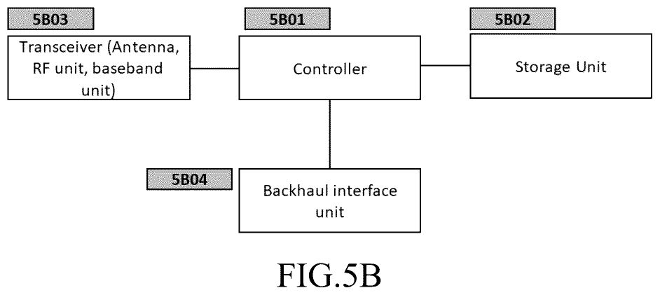

FIG. 5A is a block diagram illustrating the internal structure of a Terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

FIG. 5B is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in FIG. 2A are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to deter mine whether to provide the terminal with multi-connection or to discontinue the same. In addition, the storage unit (5B02) provides stored data at a request of the controller (5B01).

The transceiver (5B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | | |
| SDU | Service Data Unit | | |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

What is claimed is:

1. A method performed by a terminal, the method comprising:
receiving a radio resource control (RRC) message, wherein the RRC message comprises a set of configuration parameters for a secondary cell (SCell); and
starting a measurement on the SCell:
at a first time point in case that the SCell is a first type SCell or a second type SCell; and
at a second time point in case that the SCell is a third type SCell,
wherein the SCell is the first type SCell in case that the set of configuration parameters for the SCell:
comprises a first parameter; and
does not comprise a second parameter,
wherein the SCell is the second type SCell in case that the set of configuration parameters for the SCell:
does not comprise the first parameter; and
does not comprise the second parameter,
wherein the SCell is the third type SCell in case that the set of configuration parameters for the SCell:
does not comprise the first parameter; and
comprises the second parameter,
wherein:
the first time point is determined based on time point when the RRC message is received; and
the second time point is determined based on time point when a specific downlink information is received, and
wherein:
the specific downlink information comprises one or more bits; and
a specific bit of the one or more bits corresponds to the SCell.

2. The method of claim 1, wherein:
the first parameter is related to state of corresponding cell; and
the second parameter is related to transmission of a first set of downlink signals of the corresponding cell.

3. The method of claim 1, wherein:
the measurement on the SCell is performed based on discontinuous reception period in case that the SCell is the first type SCell; and
the measurement on the SCell is performed based on a measurement cycle in case that the SCell is the second type SCell.

4. The method of claim 3, wherein:
the measurement cycle is determined based on a measurement cycle parameter; and
the measurement cycle parameter is determined based on a third parameter in the set of configuration parameters for the SCell.

5. The method of claim 4, wherein:
the third parameter comprises an identifier;
the identifier indicates a set of measurement parameters; and
the set of measurement parameters comprises the measurement cycle parameter.

6. The method of claim 2, wherein:
the measurement on the SCell is performed on a second set of downlink signals;
the second set of downlink signals comprises a first synchronization signal and a second synchronization signal; and
the first set of downlink signals comprises the second set of downlink signals and a downlink signal on physical broadcast channel.

7. The method of claim 6, wherein:
the first synchronization signal is transmitted in a first symbol;
the second synchronization signal is transmitted in a second symbol; and
the first symbol and the second symbol are spaced apart by an interval of a symbol.

8. The method of claim 1, the method further comprising:
initiating a measurement reporting procedure; and
transmitting a measurement report message.

9. The method of claim 8,
wherein the measurement report message comprises a parameter for measurement results on the SCell in case that:
the SCell is the first type SCell or the second type SCell; and
a third parameter is comprised in the set of configuration parameters for the SCell.

10. The method of claim 9,
wherein the measurement report message does not comprise the parameter for measurement results on the SCell in case that the SCell is the third type SCell.

11. The method of claim 9,
wherein the third parameter indicates a set of measurement parameters associated with the SCell.

12. The method of claim 1, wherein:
the second time point is determined further based on a specific subcarrier spacing;
the specific subcarrier spacing is subcarrier spacing of a specific cell; and
the specific cell is not the SCell.

13. The method of claim 12,
wherein the second time point is determined further based on a slot where hybrid automatic retransmission request acknowledgement for the specific downlink information is transmitted.

14. A terminal in a wireless communication system, the terminal comprising:
a transceiver configured to transmit and receive a signal; and
a controller configured to control the transceiver to:
receive a radio resource control (RRC) message, wherein the RRC message comprises a set of configuration parameters for a secondary cell (SCell); and
start a measurement on the SCell:
at a first time point in case that the SCell is a first type SCell or a second type SCell; and
at a second time point in case that the SCell is a third type SCell,
wherein the SCell is the first type SCell in case that the set of configuration parameters for the SCell:
comprises a first parameter; and
does not comprise a second parameter,
wherein the SCell is the second type SCell in case that the set of configuration parameters for the SCell:
does not comprise the first parameter; and
does not comprise the second parameter,
wherein the SCell is the third type SCell in case that the set of configuration parameters for the SCell:
does not comprise the first parameter; and
comprises the second parameter,
wherein:
the first time point is determined based on time point when the RRC message is received; and
the second time point is determined based on time point when a specific downlink information is received, and
wherein:
the specific downlink information comprises one or more bits; and
a specific bit of the one or more bits corresponds to the SCell.
